(19) United States
(12) Patent Application Publication
(10) Pub. No.: US 2016/0193785 A1
(43) Pub. Date: Jul. 7, 2016

(54) 3D PRINTER FOR PRINTING A PLURALITY OF MATERIAL TYPES

(71) Applicant: Voxel8, Inc., Somerville, MA (US)

(72) Inventors: Michael Austin Bell, Somerville, MA (US); Carmen Marten-Ellis Graves, Cambridge, MA (US); Kyle Dumont, Arlington, MA (US)

(21) Appl. No.: 14/986,373

(22) Filed: Dec. 31, 2015

Related U.S. Application Data
(60) Provisional application No. 62/099,358, filed on Jan. 2, 2015.

(51) Int. Cl. B29C 67/00

(52) U.S. Cl. CPC B29C 67/0085; B29C 67/0055; B33Y 10/00

(57) ABSTRACT

A three-dimensional (3D) printer and associated 3D printing method includes (i) a dispensing system comprising removable cartridges adapted to dispense different materials, each cartridge including status pins that transfer an identity of each cartridge, properties of the build material dispenser, and/or properties of a build material disposed therein; (ii) a build surface disposed below the dispensing system; (iii) a multi-axis positioning system to position the dispensing system relative to the build surface; and (iv) status pin connections. The status pin connections are mated with some portion of the discrete status pins. A structural material is dispensed from one cartridge onto the build surface to define at least a portion of the object. A functional ink is dispensed from the other cartridge onto a region of the object.

### CROSS-REFERENCE TO RELATED APPLICATION

This application is a non-provisional patent application claiming priority of U.S. Provisional Patent Application No. 62/099,358, filed Jan. 2, 2015, which is incorporated by reference herein in its entirety.

### FIELD OF THE INVENTION

Embodiments of the invention relate to systems for and methods of three-dimensional (3D) printing and, more specifically, to a 3D printer adapted to print objects including embedded electrically conductive ink traces, and methods of printing thereof.

### BACKGROUND

Conventional 3D printers print articles of a single material or, in some cases, multiple structural materials typically having different colors or structural/mechanical properties. In some applications, 3D printers including a tool head that supports two fabrication tools have been proposed. However, the fabrication tools are typically configured for printing structural materials.

### SUMMARY

There is a need for a compact, reliable 3D printer adapted to print objects with conductive traces embedded in a structural material, to produce highly functional objects with integrated electronics in an efficient manner.

In an aspect, embodiments of the invention relate to a three-dimensional printer including a dispensing system including at least two removable cartridges adapted to dispense different materials, wherein each removable cartridge includes a plurality of discrete status pins that provide data to identify the corresponding removable cartridge and a build material disposed therein. A build surface is disposed below the dispensing system. A multi-axis positioning system is adapted to position the dispensing system relative to the build surface. Status pin connections are structured and arranged to mate with corresponding discrete status pins and configured to transfer data including at least one of an identity of each cartridge, properties of the build material dispenser, and properties of a build material disposed therein.

One or more of the following features may be included. Either or both of the removable cartridges may be a pneumatically controlled cartridge, a volumetric dispensing cartridge (e.g., an auger-type system, a syringe pump, and the like), and/or a hybrid system having both an auger-type system and a pneumatically controlled cartridge. The pneumatically controlled cartridge may be adapted for dispensing a material at room temperature. The material may include a functional ink such as conductive, magnetic, dielectric, and semiconductive materials. The material may include a matrix ink selected from the group consisting of epoxy, thermoplastics, silicones, and combinations thereof.

At least two cartridges may include pneumatically controlled cartridges, volumetric dispensing cartridges (e.g., an auger-type system, a syringe pump, and the like), and/or hybrid systems having both an auger-type system and a pneumatically controlled cartridge. One of the cartridges may be adapted for dispensing a functional ink such as conductive, magnetic, dielectric, and semiconductive materials, and the other cartridge may be adapted for dispensing a matrix ink such as epoxy, thermoplastics, silicones, and/or combinations thereof.

The dispensing system may include a fused filament fabrication (FFF) cartridge for extruding a filament. The filament may include a material such as a polymer, a composite, and a ceramic.

A dispensing tip of a first cartridge may be translatable relative to a dispensing tip of at least one other cartridge.

The first cartridge may include a pneumatically controlled cartridge that may include a capping arm adapted to cover a dispensing tip thereof.

The first cartridge may include a pneumatically controlled cartridge that may include a syringe holder for receiving a syringe therein. The pneumatically controlled cartridge may further include a rack and pinion system for translating the syringe holder therein. The pinion may include a flat portion for releasing the rack, when the syringe holder is disposed in a downward position. The syringe holder may be repeatably positioned within the pneumatically controlled cartridge with at least one of a spring and at least one magnet.

The dispensing system may include a cartridge holder for holding the removable cartridges. The cartridge holder may include a sensor for sensing a position of the build surface. The cartridge holder and each cartridge may include a kinematic coupling to repeatably position each cartridge. The kinematic coupling may include at least three balls. At least one of a cartridge and the cartridge holder may include a magnet, a clamp, and/or a clasp for retaining the cartridge in the cartridge holder.

The multi-axis positioning system may include (i) an xy-axes subsystem for positioning the dispensing system in a horizontal plane; and (ii) a z-axis subsystem for positioning the build surface in a vertical direction. The xy-axes subsystem may include dual drive motors and a single belt anchored to the dispensing system. The z-axis subsystem may include a single drive motor and a lead screw and nut assembly.

The z-axis subsystem may further include a support frame for removably supporting the build surface. The frame and the build surface may include a kinematic coupling. The kinematic coupling may include at least three balls. At least one of the build surface and the frame may include a magnet for retaining the build surface on the frame.

The pneumatic control components may be self-contained within the three-dimensional printer. The pneumatic control components may include one or more compressors.

The three-dimensional printer may include sensors with at least one of the sensors including a current monitoring circuit that monitors and generates signal data of current flow to the three-dimensional printer.

In a second aspect, embodiments of the invention relate to a three-dimensional printer including a dispensing system including at least two removable cartridges adapted to dispense different materials, wherein each removable cartridge includes a plurality of discrete status pins that provide data to identify the corresponding removable cartridge and a build material disposed therein. A build surface is disposed below the dispensing system. A multi-axis positioning system is adapted to position the dispensing system relative to the build surface. A current monitoring circuit is adapted to monitor and generate signal data of current flow to the three-dimensional printer.

In another aspect, embodiments of the invention relate to a method for three-dimensionally printing an object, including providing a three-dimensional printer including (i) a dispensing system including at least two removable cartridges adapted to dispense different materials, wherein each removable cartridge includes a plurality of discrete status pins that provide data to identify the corresponding removable cartridge and a build material therein;; (ii) a build surface disposed below the dispensing system; (iii) a multi-axis positioning system adapted to position the dispensing system relative to the build surface; and (iv) a plurality of status pin connections. The plurality of status pin connections mate with corresponding discrete status pins. The plurality of status pin connections receives status pin data to identify the corresponding removable cartridge and the build material in the cartridge. A structural material is dispensed from one of the removable cartridges onto the build surface to define at least a portion of the object. A functional ink is dispensed from another of the cartridges onto a region of the object.

One or more of the following features may be included. The functional ink may be dispensed at room temperature. The functional ink may be a conductive, magnetic, dielectric, or semiconductor material.

At least two cartridges may include pneumatically controlled cartridges. The structural material may be dispensed by a pneumatically controlled cartridge. The structural material may include a matrix ink such as epoxy, thermoplastics, silicones, and/or combinations thereof. One of the cartridges may be adapted for dispensing a functional ink such as a conductive, magnetic, dielectric, or semiconductor material, and the other cartridge may be adapted for dispensing a matrix ink such as an epoxy, thermoplastics, silicones, and/or combinations thereof.

The dispensing system may include a fused filament fabrication (FFF) cartridge for extruding a filament, and dispensing the structural material includes extruding the filament. The filament may include a material such as a polymer, a composite, and a ceramic.

A dispensing tip of a first cartridge may be translatable relative to a dispensing tip of at least one other cartridge. A first cartridge includes a pneumatically controlled cartridge that may include a capping arm adapted to cover a dispensing tip thereof. A first cartridge includes a pneumatically controlled cartridge that may include a syringe holder for receiving a syringe therein. The pneumatically controlled cartridge may further include a rack and pinion system for translating the syringe holder therein. The pinion may include a flat portion for releasing the rack, when the syringe holder is disposed in a downward position.

The syringe holder may be repeatably positioned within the pneumatically controlled cartridge with at least one magnet.

The dispensing system may include a cartridge holder for holding the removable cartridges. The cartridge holder may include a sensor for sensing a position of the build surface; the method may include using the sensor to sense a position of the build surface.

The cartridge holder and each cartridge may each include a kinematic coupling to repeatably position each cartridge. The kinematic coupling may include at least three balls. At least one of a cartridge and the cartridge holder may include a magnet for retaining the cartridge in the cartridge holder.

The multi-axis positioning system may include (i) an xy-axes subsystem for positioning the dispensing system in a horizontal plane; and (ii) a z-axis subsystem for positioning the build surface in a vertical direction. The xy-axes subsystem comprises dual drive motors and a single belt anchored to the dispensing system. The z-axis subsystem may include a single drive motor and a lead screw and nut assembly.

The z-axis subsystem may further include a frame for removably supporting the build surface. The frame and the build surface may include a kinematic coupling. The kinematic coupling may include at least three balls. At least one of the build surface and the frame may include a magnet for retaining the build surface on the frame. Current may be transmitted through the kinematic coupling.

Pneumatic control components may be self-contained within the three-dimensional printer. The pneumatic control components may include one or more compressors.

In still another aspect, embodiments of the invention relate to a three-dimensional printer. The printer includes a dispensing system; a build surface disposed below the dispensing system; a multi-axis positioning system adapted to position the dispensing system relative to the build surface; and a temperature control unit in thermal communication with the build surface for controlling the temperature of the build surface. In some variations, the printer includes one or more of a key resistor and/or a thermistor formed in the thermal control unit.

In yet another aspect, embodiments of the invention relate to a method for three-dimensional printing an object. The method includes providing a three-dimensional printer including (i) a dispensing system; (ii) a build surface disposed below the dispensing system; (iii) a multi-axis positioning system adapted to position the dispensing system relative to the build surface; and (iv) a temperature control unit in thermal communication with the build surface for controlling the temperature of the build surface. A structural material is dispensed from one of the removable cartridges onto the build surface to define at least a portion of the object. A functional ink is dispensed from another of the cartridges onto a region of the object. In some variations, the method further includes controlling the temperature of the build surface during three-dimensional printing. For example, the build surface may be heated to a temperature between about 70 and about 290 degrees Fahrenheit.

In a further aspect, embodiments of the invention relate to a cartridge for dispensing a build material onto a build surface for use with a three-dimensional printer. The cartridge includes a support frame for retaining a build material dispenser. An array of discrete status pins are structured and arranged to transfer data including an identity of the cartridge, properties of the build material dispenser, and/or properties of a build material disposed therein. In some implementations, the support frame includes a syringe holder structured and arranged to hold an insertable syringe. In one variation, the syringe holder includes a hollow elongate portion having a cylindrical plenum for receiving the syringe in a friction fit; a dispensing nozzle in fluid communication with the inserted syringe; and magnets for retaining the syringe holder in a desired orientation within the cartridge.

In some applications, properties of the build material dispenser data include a nozzle diameter and/or an ambient temperature; build material properties data include a type of build material, a quantity of build material available, and/or a temperature of the build material; and/or identity of the cartridge data includes an error state of the cartridge and/or a cartridge serial number.

One or more of the following features may be included. A capping mechanism may be provided to cover a dispensing tip of the dispensing nozzle when not printing. Slots and/or grooves may be formed in a bottom surface of the cartridge for kinematic coupling the cartridge at a same location and orientation in a cartridge holder. Magnets, clamps, clasps, and/or any combination thereof may be disposed at discrete locations in a bottom surface of the cartridge for coupling the cartridge at a same location and orientation in a cartridge holder. A z-axis positioning device may be included. Sensors including a current monitoring circuit may be provided to monitor current flow and generate signal data of current flow to the three-dimensional printer.

In a further aspect, embodiments of the invention relate to a cartridge for dispensing a build material onto a build surface for use with a three-dimensional printer that includes a support frame for retaining a build material dispenser. The cartridge also includes sensors, including a current monitoring circuit to monitor current flow and generate signal data of current flow to the three-dimensional printer.

In another aspect, embodiments of the invention relate to a three-dimensional printer including a dispensing system, a build surface disposed below the dispensing system, and a multi-axis positioning system adapted to position the dispensing system relative to the build surface. Status pin connections may be structured and arranged to mate with corresponding discrete status pins and further configured to transfer data, such as an identity of each cartridge, properties of the build material dispenser, and/or properties of a build material disposed therein.

In yet another aspect, embodiments of the invention relate to a three-dimensional printer including a dispensing system, a build surface disposed below the dispensing system, and a multi-axis positioning system adapted to position the dispensing system relative to the build surface. A current monitoring circuit may be provided to monitor current flow and generate signal data of current flow to the three-dimensional printer.

### BRIEF DESCRIPTION OF DRAWINGS

The foregoing features and advantages of embodiments of the invention will become more apparent from a reading of the following description in connection with the accompanying drawings, in which:

FIGS. 1, 2A, and 2B are schematic drawings of a 3D printer in accordance with embodiments of the invention;

FIG. 3 is a diagram illustrating the equations of motion of a double belt XY-axis positioning system in accordance with the prior art;

FIG. 4 is a diagram illustrating the XY-axis positioning system of FIG. 3 in accordance with the prior art;

FIG. 5 is a diagram illustrating an XY-axis positioning system according to one embodiment of the invention;

FIGS. 6A and 6B are schematic drawings illustrating use of timing belts and a synchromesh drive system with an XY-axis positioning system according to one embodiment of the invention;

FIGS. 7A and 7B are schematic drawings illustrating plan and perspective views of an XY-axis positioning system, in accordance with an embodiment of the invention;

FIGS. 8A-8J are schematic drawings of the XY-axis positioning system in operation, including anchoring of the one- and two-belt configurations, according to one embodiment of the invention;

FIG. 9A is a schematic drawing illustrating a kinematic coupling for a build surface and the support frame, according to one embodiment of the invention;

FIG. 9B is a schematic drawing illustrating a build surface installed on the support frame of FIG. 9A;

FIG. 9C is a schematic drawing illustrating a temperature control unit on a lower surface of a build surface, according to one embodiment of the invention;

FIG. 10A is an illustrative embodiment of a logic diagram for a build surface temperature control unit, according to one embodiment of the invention;

FIG. 10B is an illustrative embodiment of a circuit wiring diagram for the build surface temperature control unit of FIG. 9C;

FIG. 11A is a diagram illustrating a 3-ball kinematic coupling design for the support frame and build surface of FIG. 9B, according to one embodiment of the invention;

FIG. 11B is a diagram illustrating a 4-ball kinematic coupling design for the support frame and build surface of FIG. 9B, according to one embodiment of the invention;

FIG. 12 is a diagram illustrating a cross-sectional view of a kinematic coupling, according to one embodiment of the invention;

FIG. 13 is a diagram illustrating the use of a kinematic coupling to transmit electrical current between the support frame and the build surface of FIG. 9B, according to one embodiment of the invention;

FIG. 14 is a schematic drawing of a build surface and support frame having storage for a filament spool, according to one embodiment of the invention;

FIGS. 15A and 15B are side and perspective views illustrating a cartridge holder for a dispensing system including at least two removable cartridges, according to one embodiment of the invention;

FIG. 16 is a transparent side view and illustrating cartridge slots for removable cartridges, according to one embodiment of the invention;

FIG. 17 is a transparent side view illustrating a kinematic coupling and printed circuit board within a cartridge slot, according to one embodiment of the invention;

FIG. 18 is a transparent perspective view of a pneumatic cartridge, according to one embodiment of the invention;

FIG. 19 is a perspective view of a 3D printer, according to one embodiment of the invention;

FIG. 20 is a perspective detail view of the printing heads of the removable cartridges, according to one embodiment of the invention;

FIG. 21 is a power distribution block diagram of a portion of the 3D printer of FIG. 19, according to one embodiment of the invention;

FIGS. 22A-22F are schematic drawings illustrating a pneumatically controlled system for dispensing fluids from a cartridge, according to one embodiment of the invention;

FIG. 23 is a line diagram of an illustrative cartridge architecture, according to one embodiment of the invention;

FIG. 24 is an illustrative 2×8 array of status pins on the printed circuit board of a cartridge, according to one embodiment of the invention;

FIG. 25A is a side view of an exemplary volumetric dispensed cartridge, according to one embodiment of the invention;

FIG. 25B is a perspective view of the exemplary volumetric dispensed cartridge of FIG. 25A, according to one embodiment of the invention; and

FIG. 26 is an illustrative embodiment of a handshake function for initiating or re-initiating 3D printing, according to one embodiment of the invention.

### DETAILED DESCRIPTION

Embodiments of the invention include a 3D printer that contains the system, hardware, electronics, software, and materials needed to 3D print an object or device, e.g., a fully functional electronic device, or an object suitable for connection to other components. More specifically, in some embodiments the printer head tool of the 3D printer includes multiple, e.g., two, replaceable cartridges that are structured and arranged to dynamically register with a system processing device. At least one of the cartridges may be configured to disperse a structural material, while at least one other of the cartridges may be configured to disperse a functional material, e.g., a functional ink. In some variations, the build surface may be adapted to heat the 3D-printed object or part.

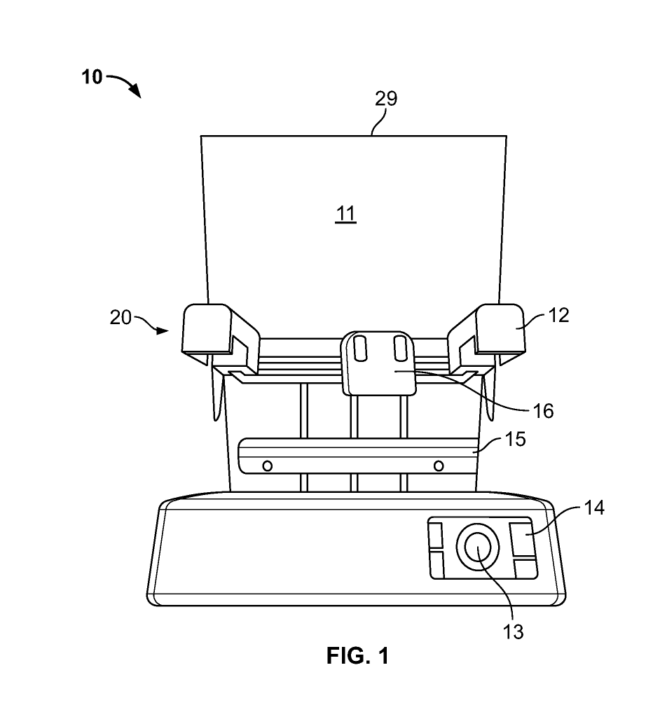

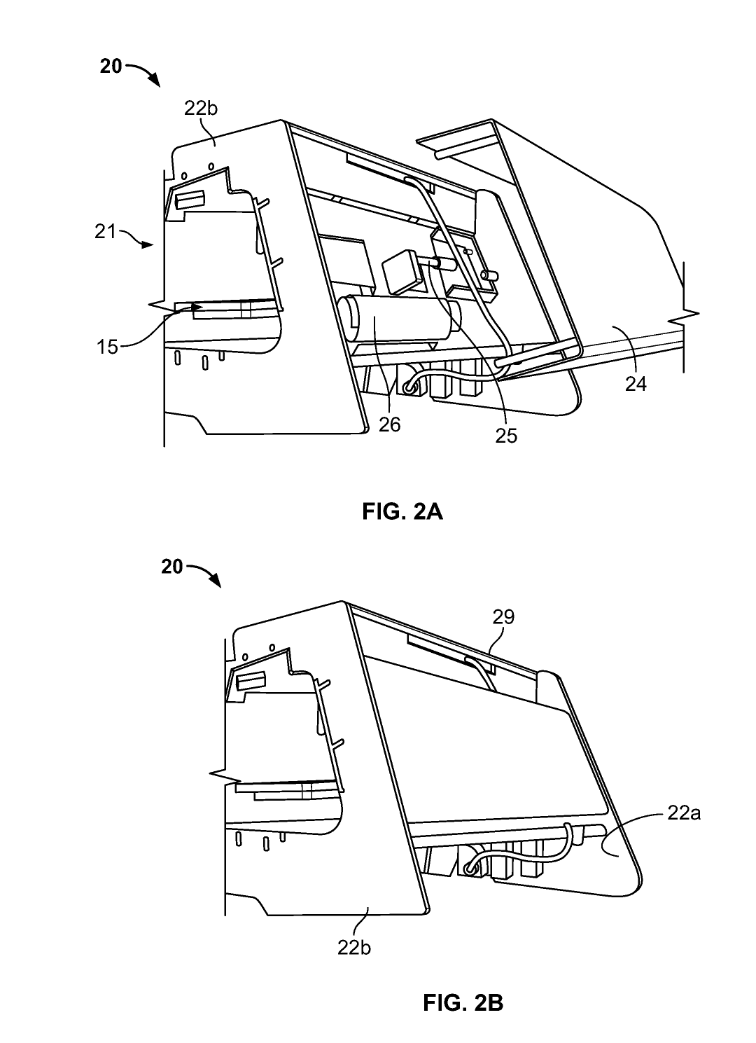

Referring to FIGS. 1, 2A, and 2B, a, e.g., trapezoid-shaped, 3D printer 10 is designed to ensure high visibility during the printing of parts. For example, in some embodiments, the 3D printer 10 includes a structural frame 20, a build surface 15, a multi-axis positioning system 12, and a processing device or controller 14 having a user interface 13. In one variation, the frame 20 of the printer 10 includes a pair of opposing C-shaped supports 22a, 22b that eliminate a need for vertical supports in the front 21 of the 3D printer 10. A top portion 29, the build surface 15, and/or multi-axis positioning system 12 are securely attached to the C-shaped supports 22a, 22b to provide lateral support and to eliminate a need for a front frame edge. In some implementations, a clear plastic door 11, may be provided to allow access to the build surface 15 and the printer head 16 (including the printer cartridges). The door 11 can be mounted and attached, e.g., with hinges to swing upwards. When in the open position, the door 11 can rest on the top portion 29 or the removable back mounting panel 24. The door 11 can alternatively be mounted with grooves and tracks, to reduce the vertical height of the door 11 while open, or can simply be a separate piece resting on the printer housing.

The trapezoidal shape of the frame provides space in the back of the 3D printer 10 for housing and mounting pneumatics 26, portions of the positioning system 25, and other electronics associated with operation of the controller 14 and the printer 10. Advantageously, housing and mounting pneumatics 26, portions of the positioning system 25, and other electronics associated with operation of the controller 14 internally provides a compact, efficient form factor. Moreover, open access to the build surface 15 provides clear line-of-sight to the 3D printing and facilitates manually inserting components into the 3D-printed object during pauses in 3D printing.

### Multi-Axis Positioning Systems

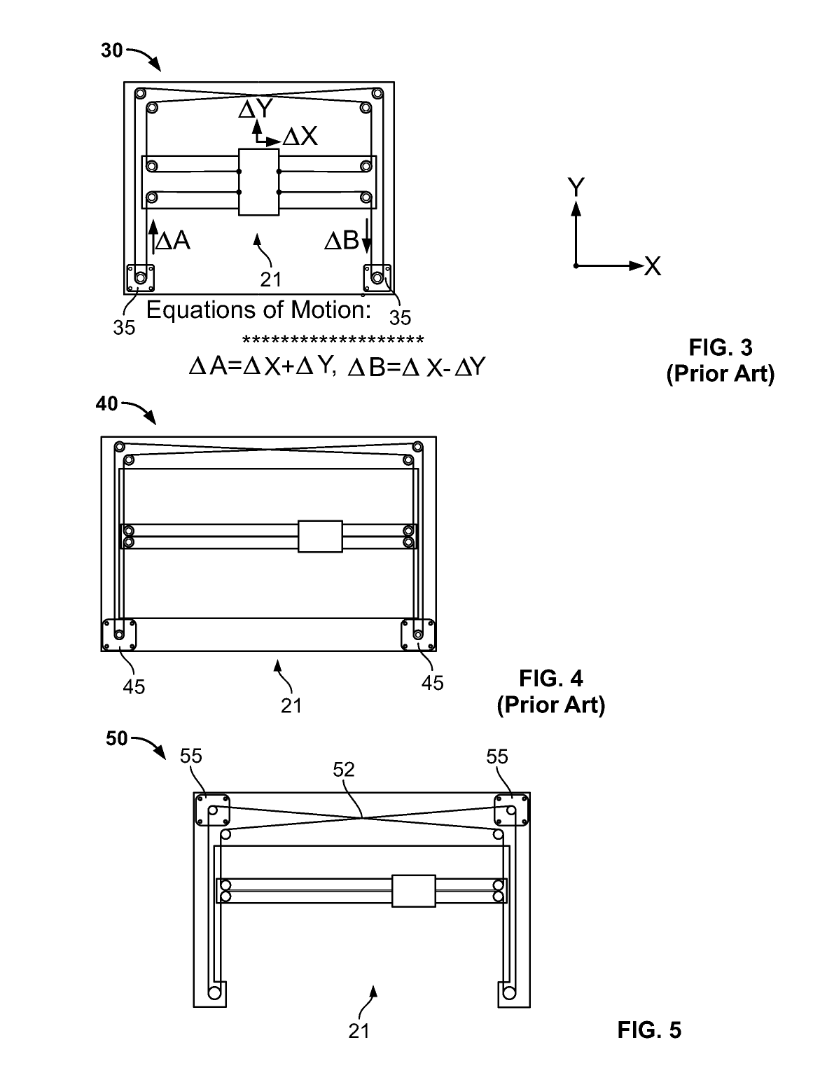

FIGS. 3-5 show illustrative embodiments of conventional XY-axis positioning systems 30, 40, 50 for a 3D printer. Disadvantageously, the XY-axis positioning systems 30, 40 in FIGS. 3 and 4 include motors 35, 45 at the front 21 of the 3D printer. In contrast, the XY-axis positioning system 50 in accordance with embodiments of the invention and depicted in FIG. 5 has rear-mounted motors 55 to provide an open front to increase visibility of the build surface 15 at the front 21. Advantageously, moving motors 55 from the front corners to the back corners (i.e., the corners involved in the drive belt cross-over 52) provides an open front 21 and better weight distribution, increasing access to the build surface 15 and build material spool located in the base.

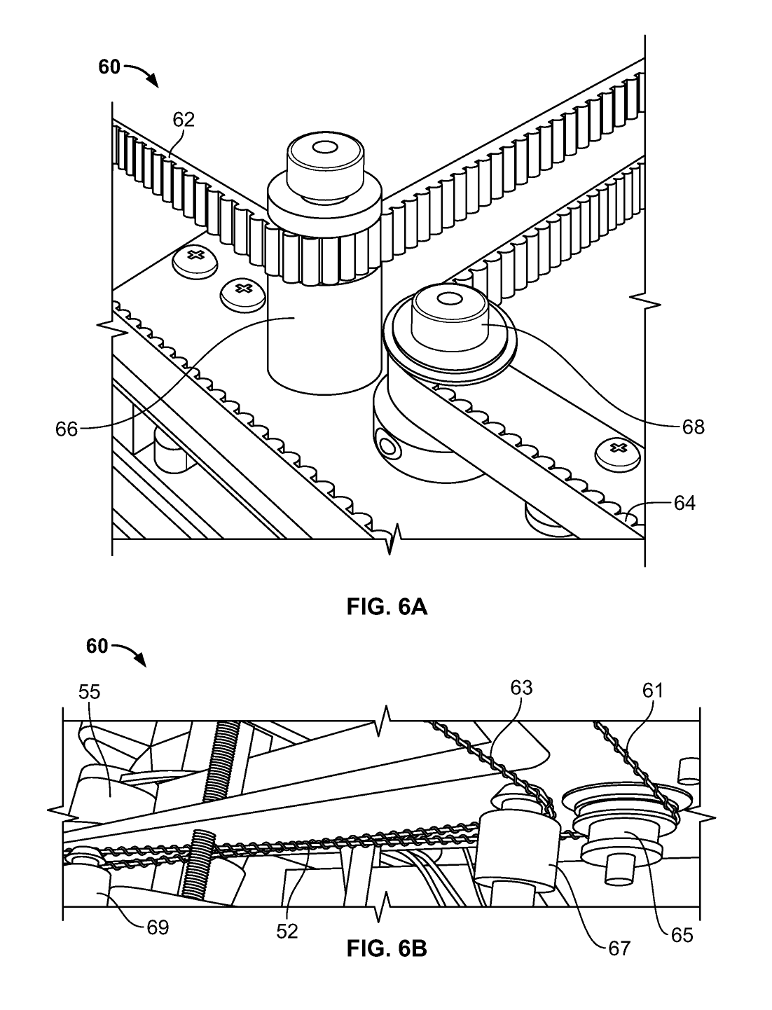

As shown in FIG. 6A, the XY positioning system 50 of the 3D printer 10 in FIG. 5 can utilize many types of belts 62, 64, e.g., synchromesh, timing belts, and the like, for positioning the tool head 16. To address the drive-belt cross-over 52, when using timing belts 62, 64, the two belts 62, 64 need to be vertically offset. For example, as shown in FIG. 6A, the idler 66 for a first belt 62 and the idler 68 for a second belt 64 are structured and arranged so that the first belt 62 remains above the second belt 64.

In another variation, synchromesh 61, 63, which has a much smaller profile than timing belts and, consequently, can more easily be maneuvered in three-dimensions, may be used instead of timing belts. Advantageously, referring to FIG. 6B, the idlers 65, 67 for the XY-axis positioning system 60 may be maintained at the same or substantially the same level, which produces a smaller, cleaner, and less intrusive profile than is possible with timing belts. With synchromesh, only the drive pulleys 69 at the motor 55 need to be vertically offset to address drive-belt cross-over 52.

Advantageously, a synchromesh drive belt system enables use of a single belt, which allows for easier tensioning, for example with a single adjustment or a single, spring loaded idler. In contrast, with timing belts, two belts are needed and it can be difficult to tension them both to the same tension, resulting in inaccurate positioning of the print cartridges and, accordingly, an inaccurate part print geometry. Accordingly, a one-belt synchromesh positioning system, in some applications, may be preferable.

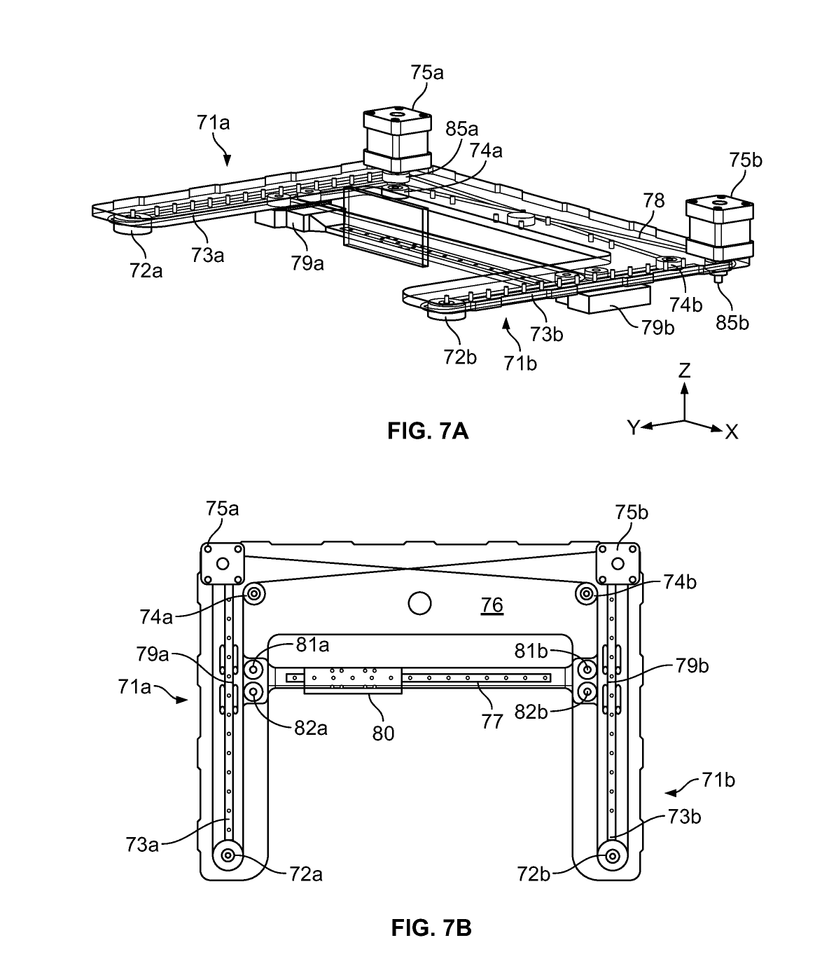

FIGS. 7A and 7B depict an illustrative embodiment of a single drive belt XY-axis positioning system 70 with anchor points and tensioner removed for clarity. Drive motors 75a, 75b may be disposed at the back corners. The C-shaped (or U-shaped) frame 76 includes a pair of opposing, parallel or substantially parallel arms 71a, 71b, each of which supports, e.g., on a lower side, a distal idler 72a, 72b, a proximal idler 74a, 74b, and a gantry support rail 73a, 73b along which a corresponding slide 79a, 79b is structured and arranged to displace in a y-direction.

The slides 79a, 79b are structured and arranged to support a gantry 77, as well as to support and translate the tool head platform 80 in the x-direction. Each slide 79a, 79b further includes a first 81a, 81b and a second idler 82a, 82b. In some implementations, the single drive belt 78, e.g., a synchromesh belt, is routed as shown about the drive pulleys 85a, 85b operatively coupled to the motors 75a, 75b and about the proximal 74a, 74b, distal 72a, 72b, and first 81a, 81b and second idlers 82a, 82b. The slides 79a, 79b and the tool head platform 80 are removably attached to the single drive belt 78 in at least two discrete locations, such that movement of the single drive belt 78 will cause linear, uniaxial (as explained below) displacement of the slides 79a, 79b (in the y-direction) and/or the tool head platform 80 (in the x-direction).

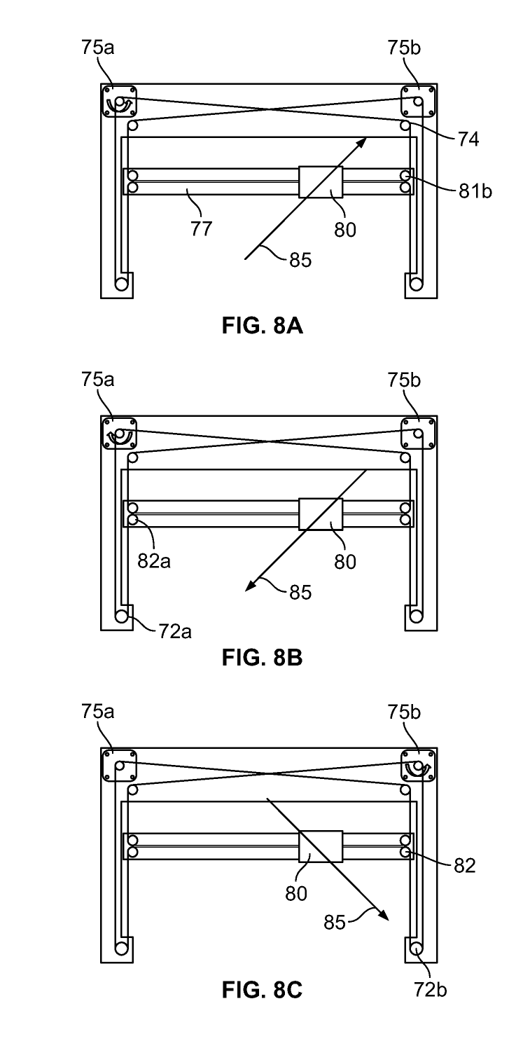

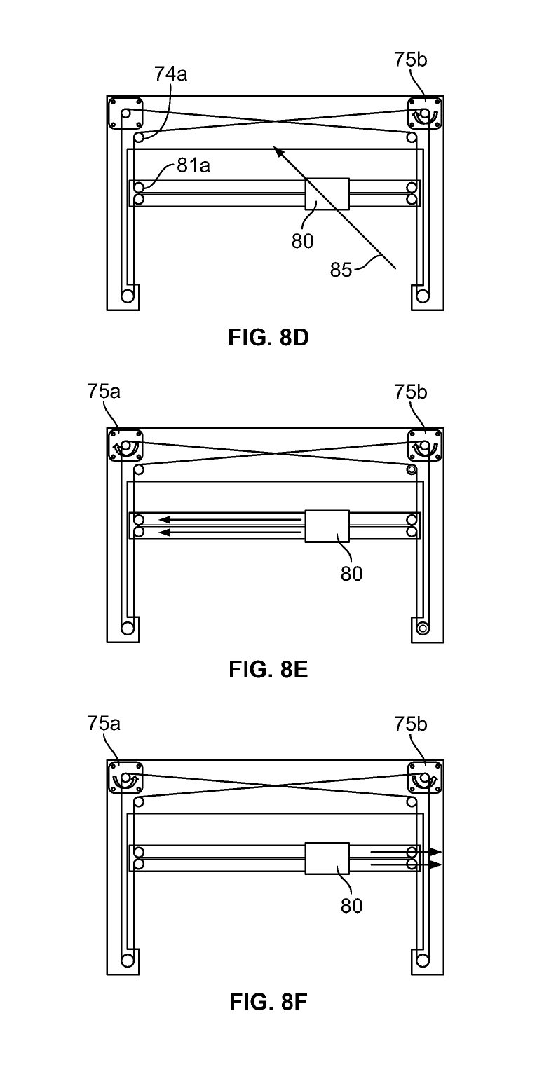

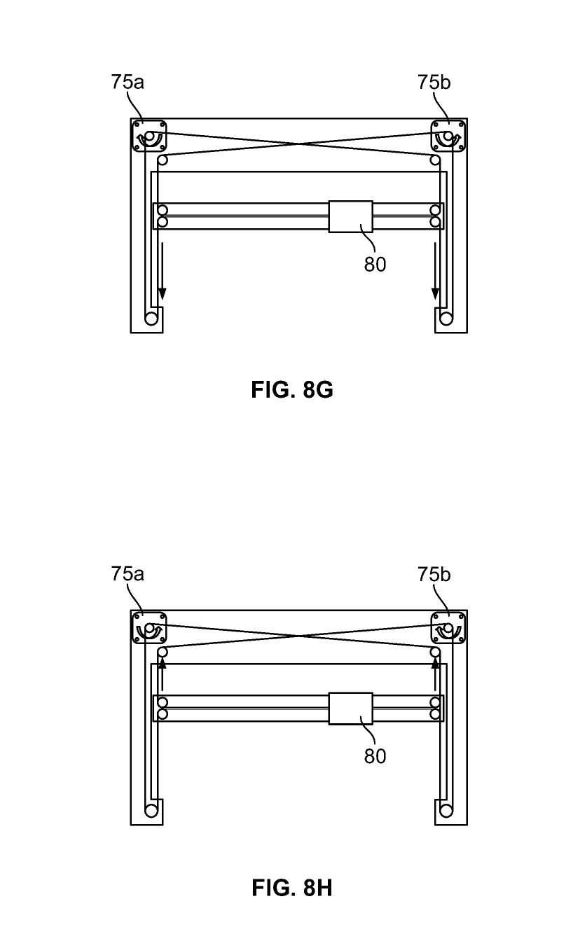

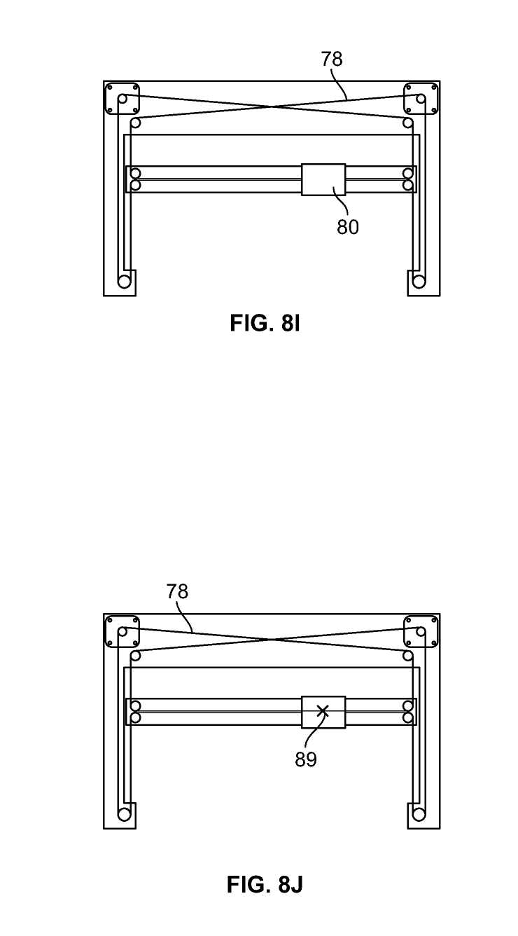

FIGS. 8A-8H depict the motion of the tool head platform, i.e., a print cartridge holder 80, in the XY-plane, based on actuation of one or both drive motors 75a, 75b in a two-belt system. As shown in FIG. 8A, rotating the left motor 75a in a counter clockwise direction results in diagonal movement 85 of the holder 80 to the upper right, i.e., towards first idler 81b and proximal idler 74b. As shown in FIG. 8B, rotating the left motor 75a in a clockwise direction reverses the diagonal direction 85 of the holder 80, i.e., towards second idler 82a and distal idler 72a.

Referring to FIG. 8C, rotating the right motor 75b in a counter clockwise direction results in diagonal movement 85 of the holder 80 to the lower right, i.e., towards second idler 82b and distal idler 72b. As shown in FIG. 8D, clockwise rotation of the right motor 75b results in diagonal movement 85 of the holder 80 in the opposite direction to the upper left, i.e., towards first idler 81a and proximal idler 74a.

Coordinated movement of both motors 75a, 75b allows for movement of the cartridge holder 80 in other directions and, in particular, right-to-left (x-direction) movement and front-to-back (y-direction) movement. For example, referring to FIGS. 8E and 8F, rotating both motors 75a, 75b in a clockwise direction moves the holder 80 in the x-direction to the left and rotating both motors 75a, 75b in a counterclockwise direction moves the holder 80 in the x-direction to the right.

Referring to FIG. 8G, coordinated rotation of the left motor 75a in a clockwise direction and the right motor 75b in a counter clockwise direction moves the holder in the y-direction from back-to-front. Referring to FIG. 8H, rotation of the left motor 75a in a counterclockwise direction and the right motor 75b in a clockwise direction moves the holder in the y-direction from front-to-back.

As depicted in FIGS. 8I and 8J, control for one belt and two belts is substantially the same. When using one belt 78 (FIG. 8I), the top portion where the two belts are typically anchored, are instead connected. The connection, however, does not move with respect to the x-direction carriage holder 80. In one variation (FIG. 8J), the single belt 78 may be clamped to the middle 89 of the carriage holder 80 to provide an effect that would be substantially the same as two belts.

### Build Surface and Support Frame

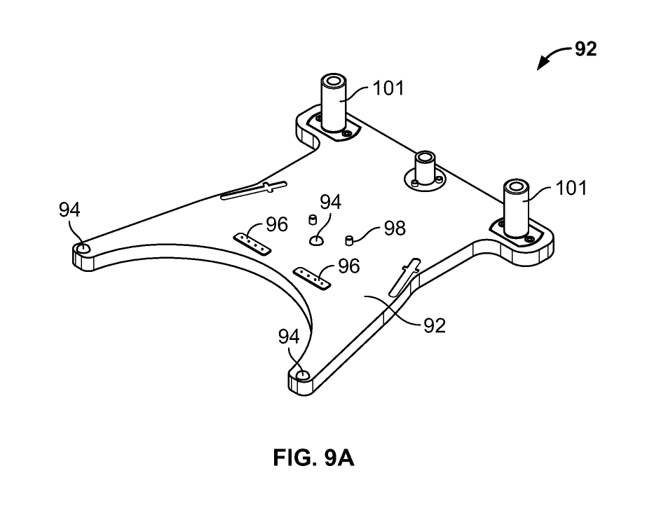

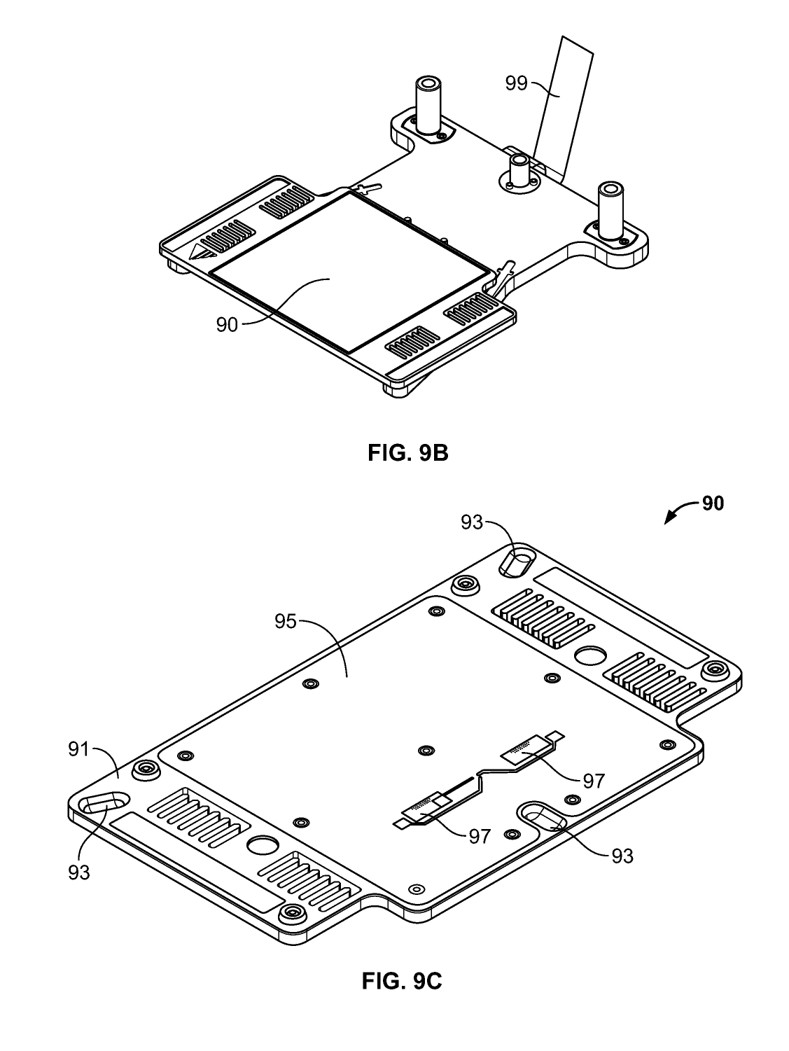

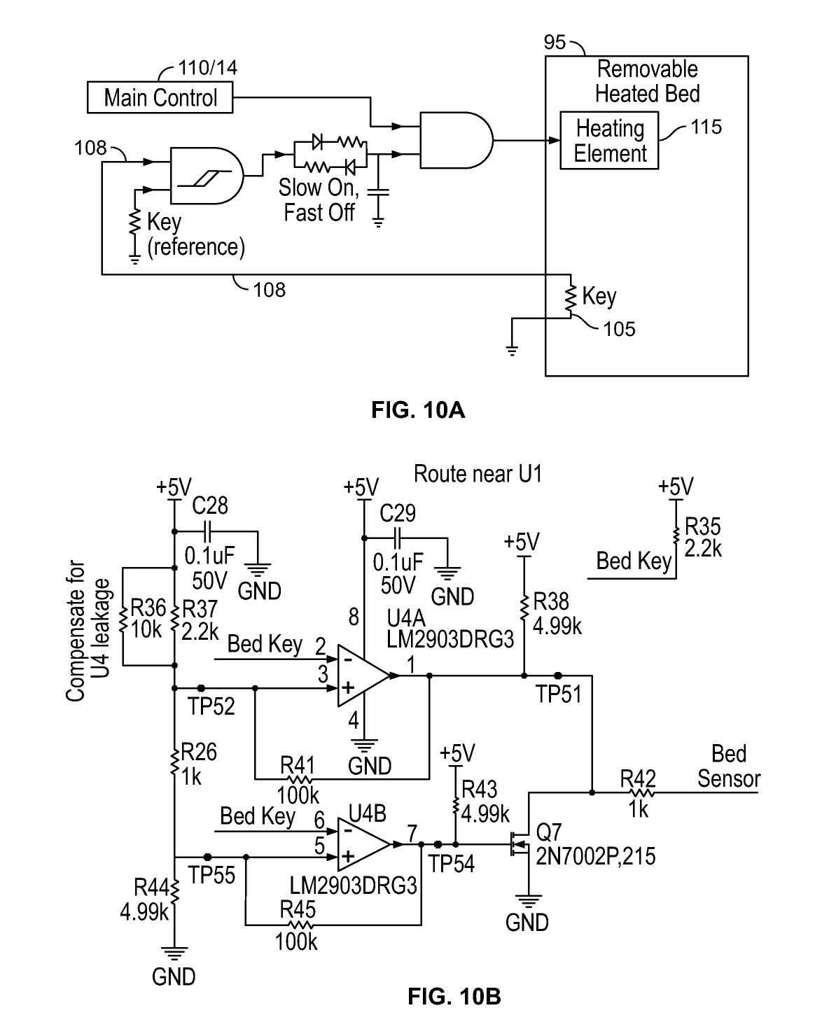

FIGS. 9A-9C depict an illustrative embodiment of a support frame 92 and a build surface 90 that is quickly removable, accurately replaceable, and precisely registerable with the dispensing system. In some implementations, the metal, e.g., aluminum, build surface 90 can be supported on a C-shaped support frame 92. In some variations, a plurality of, e.g., three or more, kinematic coupling ball bearings 94 (discussed below) may be recessed in the frame 92 in a triangular pattern about the “C.” The reverse side of the build surface 90 (FIG. 9C) is structured and arranged to include a corresponding plurality of kinematic coupling slots 93, into which each corresponding kinematic coupling ball bearing 94 fits (discussed below). A plurality of, e.g., two, registration pins 98 project from the surface of the support frame 92 to help registering the build surface 90. A plurality of, e.g., two, electrical connections 96, may be formed in the support frame 92. In some embodiments, the electrical connections 96, e.g., spring-loaded electrical type connections, may provide and control current flow to a temperature control unit 95 and/or can sense the presence or the absence of the build platform 90, e.g., via a key resistor 105 (FIGS. 10A and 10B), and generate and transmit sensor signals 108, e.g., via a flexible cable 99, to a system controller 110 to prevent printing until the electrical connections 96 sense the presence and the sensors associated with the kinematic couplings confirm the proper registration of the build surface 90 on the support platform 92.

After proper placement and registration, the build surface 90 may be moved in the z-axis, e.g., vertically, using, for example, a lead screw, a ball nut, a stepper motor, and the like that can be controlled manually or by a controller. In some implementations, the build surface 90 rides along vertically disposed metal rails, e.g., using spaced brass bushings for low friction and ease of travel. The lead screw, ball nut, stepper motor, and the like in combination with the metal rails and bushings form a z-carriage.

The build surface 90, or print bed, can be removed from the frame 92 and/or the z-carriage at any time, including during the middle of a print cycle, so that the user can insert or place components on or in the 3D-printed object easily. The z-carriage may be “U-” or “C-” shaped to allow for replacing a spool 145 of filament build material disposed in the base 140 (see FIG. 14).

Advantageously, the working temperature of the build surface 90 may be controlled, e.g., heated or cooled, by a temperature control unit 95. Although the invention will be described for the case in which the build surface 90 is heated, those of ordinary skill in the art can appreciate that the temperature control unit 95 may also be used to reduce the temperature of the build surface 90. Controlling the temperature of the build surface, whether by heating or by cooling, can be used to alter or modify the curing time and/or the curing process during the 3D printing process.

For example, in some implementations, the temperature control unit 95 is adjustable and capable of selectively heating the build surface 90 to temperatures that may range between 20 and 140 degrees Centigrade (about 70 to 290 degrees Fahrenheit). The temperature control unit 95 can include a two-layer printed circuit board (PCB) having a resistive element that provides a calibrated resistance (heat), a Peltier device, and the like. As shown in FIG. 9C, the temperature control unit 95 can be removably attached, e.g., using screws, bolts, and the like, to the lower surface of the build surface 90 to thermally couple the temperature control unit 95. In one variation, the lower surface of the build surface 90 can include a recessed area, e.g., about 1.5-2.0 mm deep, that is shaped to receive the, e.g., 1.6 mm in height, temperature control unit 95.

In some embodiments, the build surface 90 includes a pair of electrical connections 97 that are structured and arranged to be in registration with corresponding electrical connections 96 on the support frame 92 when the build surface 90 is properly installed in the support frame 92. Electrical connections 97 in the temperature control unit 95 may be of the type previously described.

The temperature control unit 95 may include a first sensor, i.e., a key resistor 105, that is in electrical communication with the electrical connection(s) 97. The key resistor 105 can be adapted to detect, by itself or in combination with another sensor(s), the presence of heated bed 95. Advantageously, once the key resistor 105 detects the presence and proper registration of the build surface 90, current (power) may be provided to the resistive element of the temperature control unit 95 to heat up the build surface 90. A thermistor may also be provided with the PCB to measure the temperature of the build surface 90 and to generate and transmit temperature signals e.g., via the flexible cable 99, to the system controller to provide temperature control of the build surface 90. An exemplary logic diagram for a build surface temperature control unit 95 and an illustrative circuit wiring diagram for the build surface temperature control unit 95 according to some embodiments of the invention are shown in FIGS. 10A and 10B.

### Kinematic Couplings

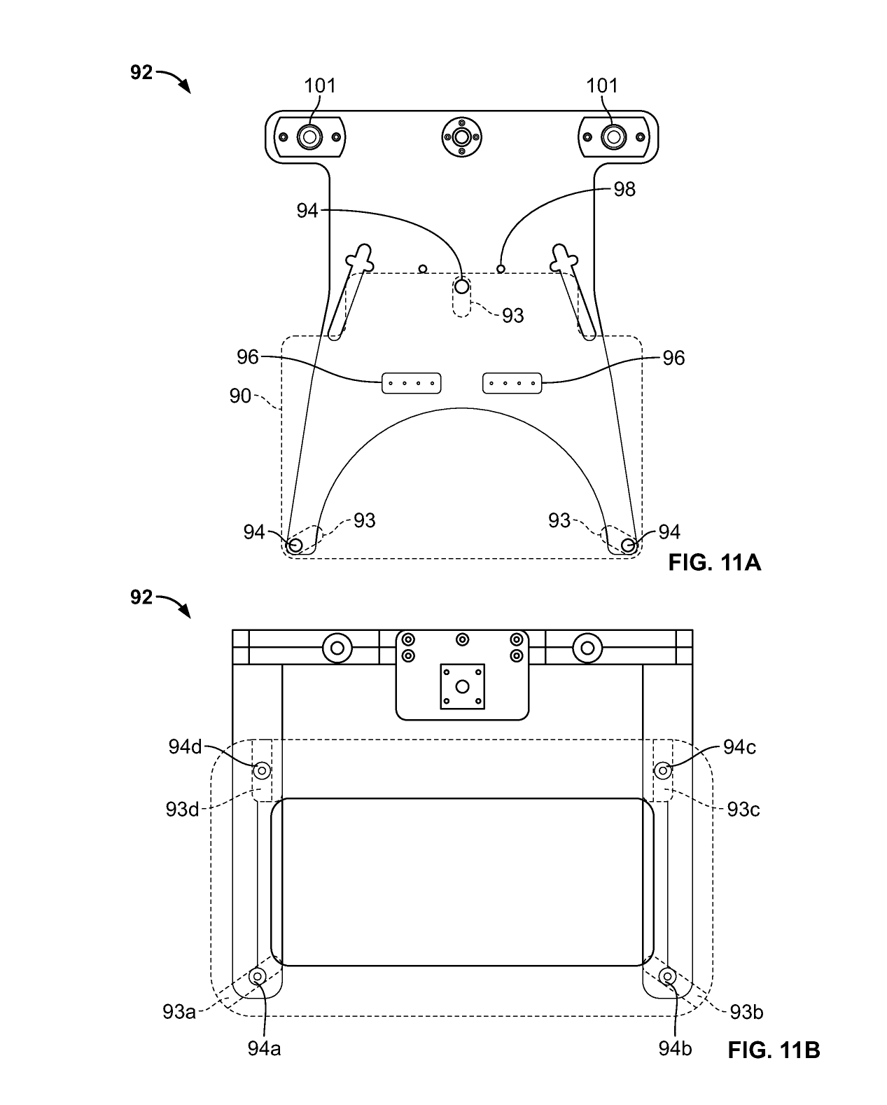

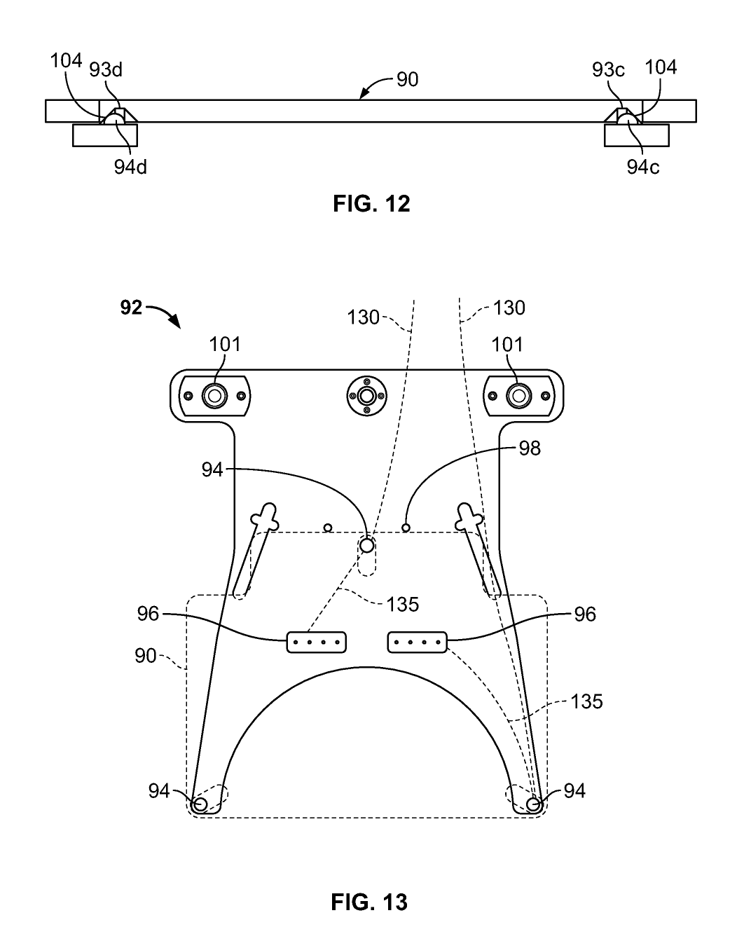

Kinematic couplings are structured and arranged to ensure that, after a build surface 90 is removed from the support frame 92 (e.g., to manually add electrical components to the 3D-printed object, to remove the printed object from the build surface 90, or to take some other action), when replaced, the build surface 90 will be in the same or substantially the same position and orientation, allowing the 3D printing to continue where it left off when the build surface 90 was removed. In some embodiments of the invention, the support frame 92 and the lower surface of the build surface 90 are structured and arranged to mate with each other using kinematic couplings 93, 94 that, referring to FIGS. 11A, 11B, and 12, include a plurality, e.g., three (3) or four (4), ball bearings 94 that are structured and arranged to mate with corresponding grooved channels 93 formed on the lower surface of the build surface 90. Such an arrangement may provide six (6) points of contact between the ball bearings 94 and the grooves 93.

For example, in the 4-ball kinematic coupling design shown in FIG. 11B, each of the front two ball bearings 94a, 94b is structured and arranged to align with the center axis of its corresponding groove 93a, 93b, to provide two points of contacts with the sidewalls of the grooves 94a, 94b. Each of the rear two ball bearings 94c, 94d, which are not aligned with the center axis of their corresponding grooves 93c, 93d, as shown in FIG. 12, only contacts one side 104 of the groove 93c, 93d each. Optionally, grooves 93a, 93b for the top two ball bearings 94a, 94b may be manufactured to be wider, so that only one surface of the groove 93a, 93b contacts the ball bearing 94a, 94b. This may be accomplished by pursuing multiple passes with a grooved end mill, or a deeper, wider, larger grooved end mill.

In some implementations, magnets can be used to preload the build surface 90 on the coupling ball bearings 94, further ensuring reliable and repeatable positioning.

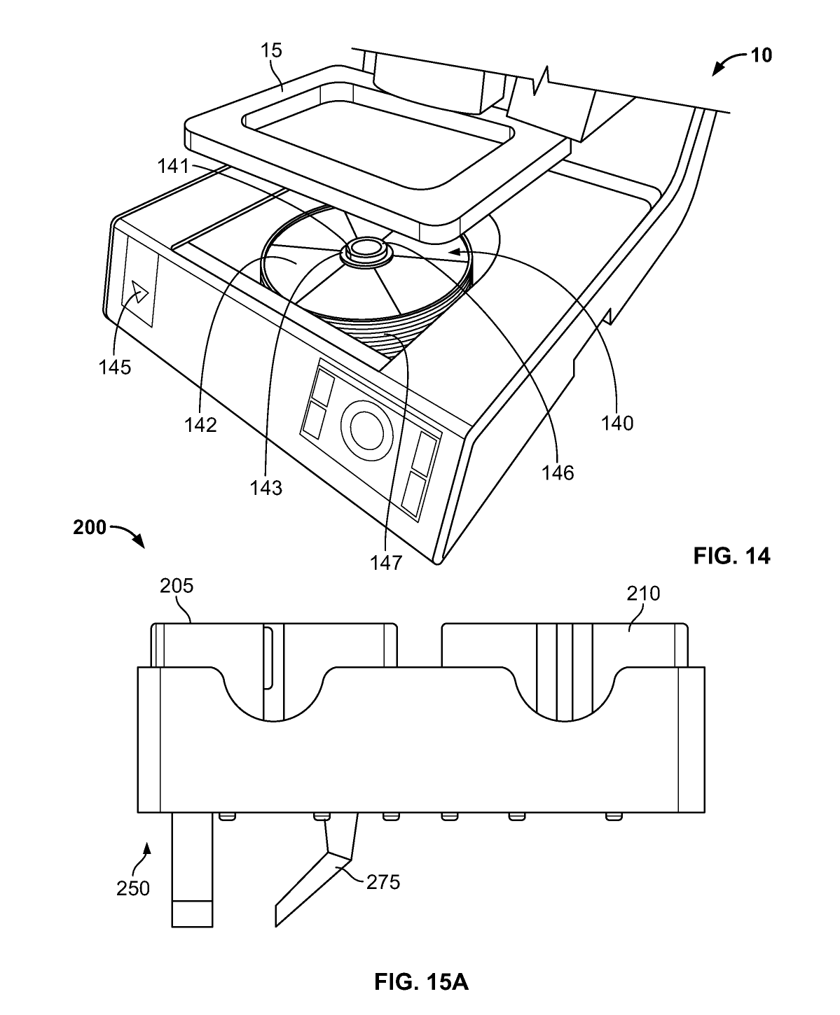

In some variations, referring to FIG. 13, transmitting current through the kinematic couplings allows for heating the build surface 90, e.g., using a resistive heater 115, to allow for, i.e., better adhesion of printed objects to the build surface 90, if desired. Accordingly, a small voltage may be applied to the temperature control device 95 through the kinematic coupling. For example, current-carrying wires 130 may be routed through the support frame 92 to at least two of the, e.g., electrically conductive, ball bearings 94 and current-carrying wires 135 may be routed through the build surface 90 to the resistive heater 115. When properly seated, the electrical-conductive ball bearings 94 complete the circuits to conduct current from the support frame wires 130 to the resistive heater wires 135 to warm the build surface 90.

To the extent that the build surface 90 is not perfectly level and parallel to the XY-plane, at least one sensor may be mounted to an XY-cartridge holder 80 (discussed above in connection with FIG. 7B) to probe the bed of the build surface 90 at a plurality of discrete locations, e.g., three to nine locations, and the z-axis can be repositioned by the system control software to auto-correct. The sensor can be an inductive sensor, a bump sensor, a magnetic sensor, etc. and utilize, for example, appropriate firmware.

### Dispensing System

Having described a 3D printer 10 having, in some embodiments, a build surface 90 including a temperature control unit 95, a support frame 20 including registration and sensing devices, and a multi-axis positioning system 70 for precisely positioning a dispensing system above the build surface 90, a multi-cartridge dispensing system 200 and replaceable cartridges 205, 210 for the same will now be described.

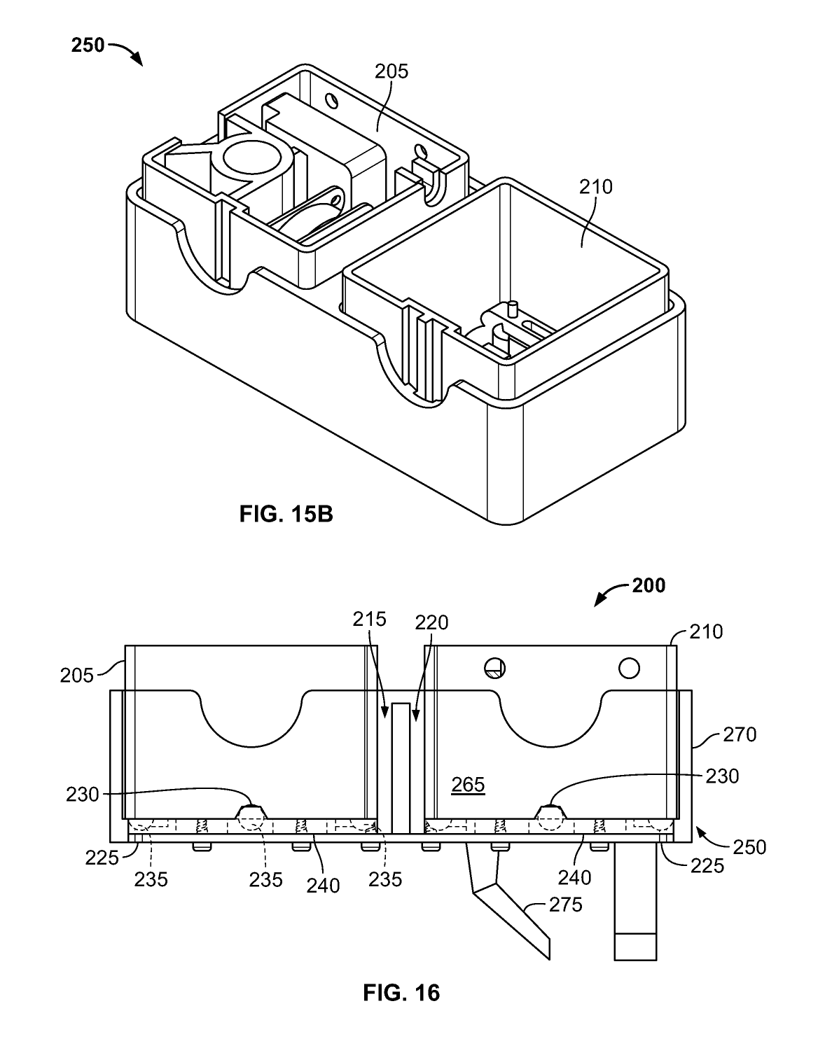

Referring to FIGS. 15A-20, in some embodiments, the dispensing system 200, i.e., a multi-cartridge dispensing system, may include a cartridge holder 250 having a plurality of, e.g., four, sidewalls 265, 270 and a base portion 225 structured and arranged to receive at last one cartridge, e.g., two cartridges 205, 210. The cartridge holder 250 is structured and arranged to hold and retain at least one of: a printed circuit board (PCB) or cartridge controller 240, for sensing, inter alia, the presence and nature of each discrete cartridge 205, 210 and for controlling dispensing the build material in the cartridge 205, 210; a coupling system 230, 235, e.g., a kinematic coupling system for reliably and repeatably retaining each cartridge 205, 210 securely in the same location and at the same orientation in the cartridge holder 250; and/or a plurality of, e.g., at least two, removable cartridges 205, 210 adapted to dispense different build materials, similar build materials but having different properties, and the like. Advantageously, the PCB controller 240 and each of the cartridges 205, 210 are structured and arranged so that cartridges 205, 210 may be readily removed and re-inserted with great accuracy and without having to stop on-going 3D printing. Arrays of corresponding status contact pins/status pin contact points (or connections) formed on the PCB controller 240 and the cartridge 205, 210 enable replacement of the cartridges 205, 210 during a build cycle.

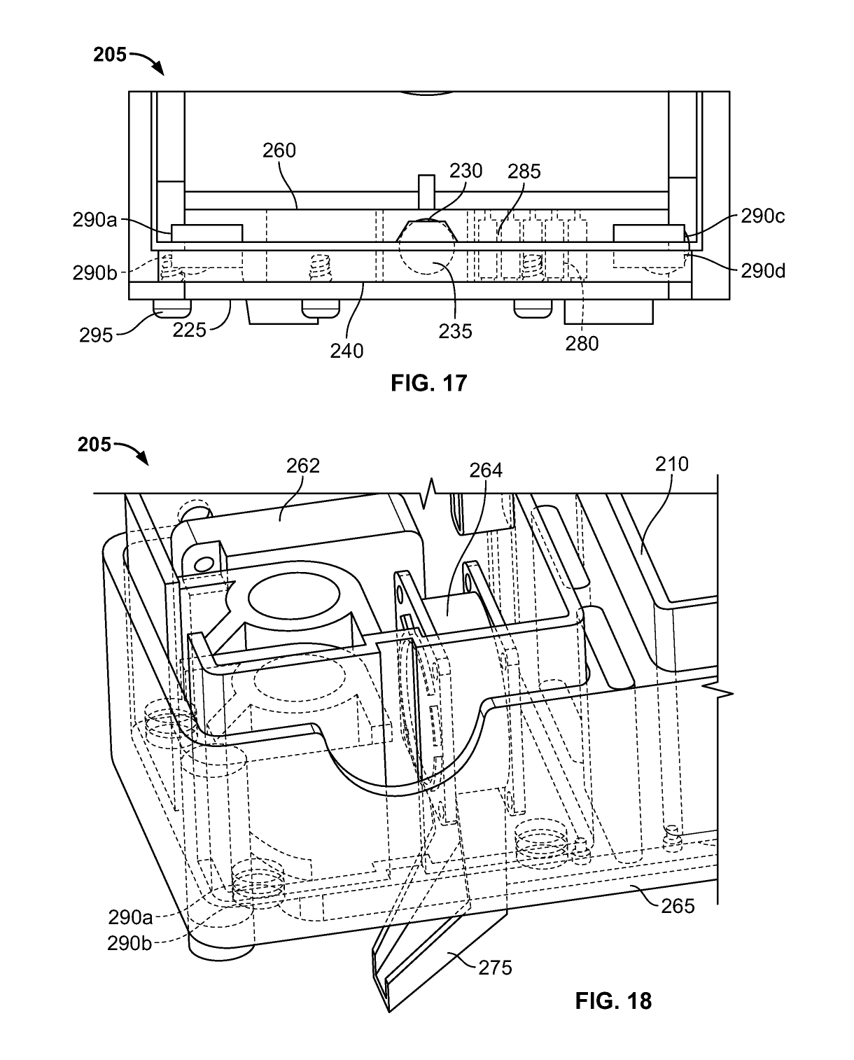

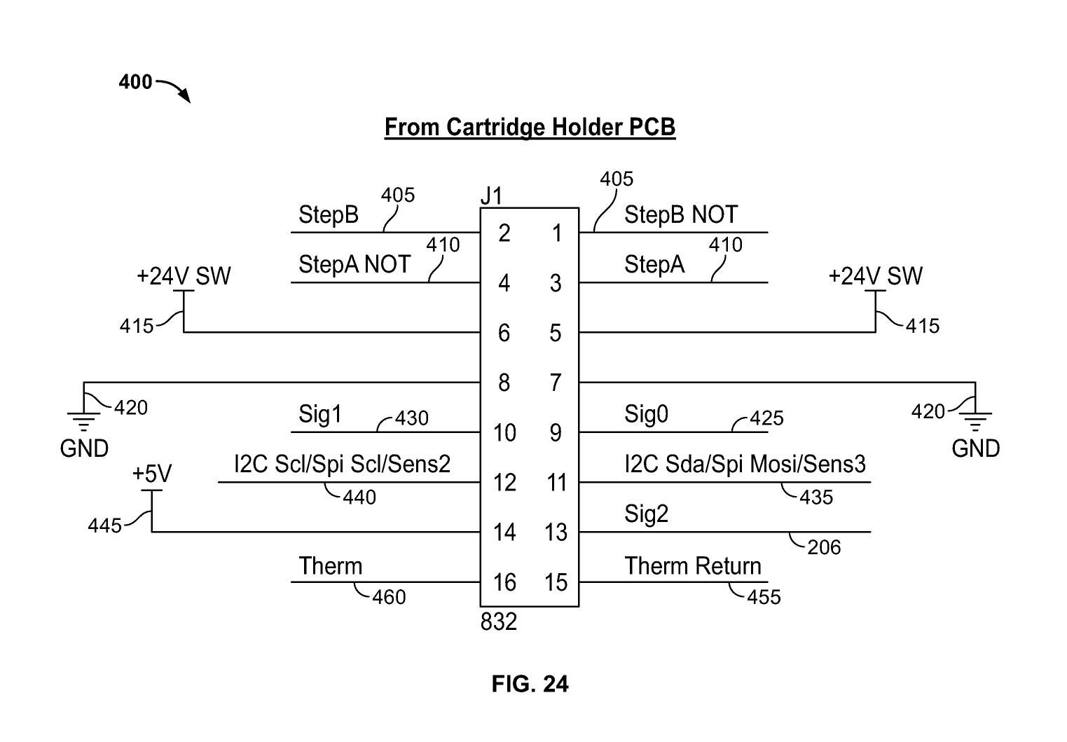

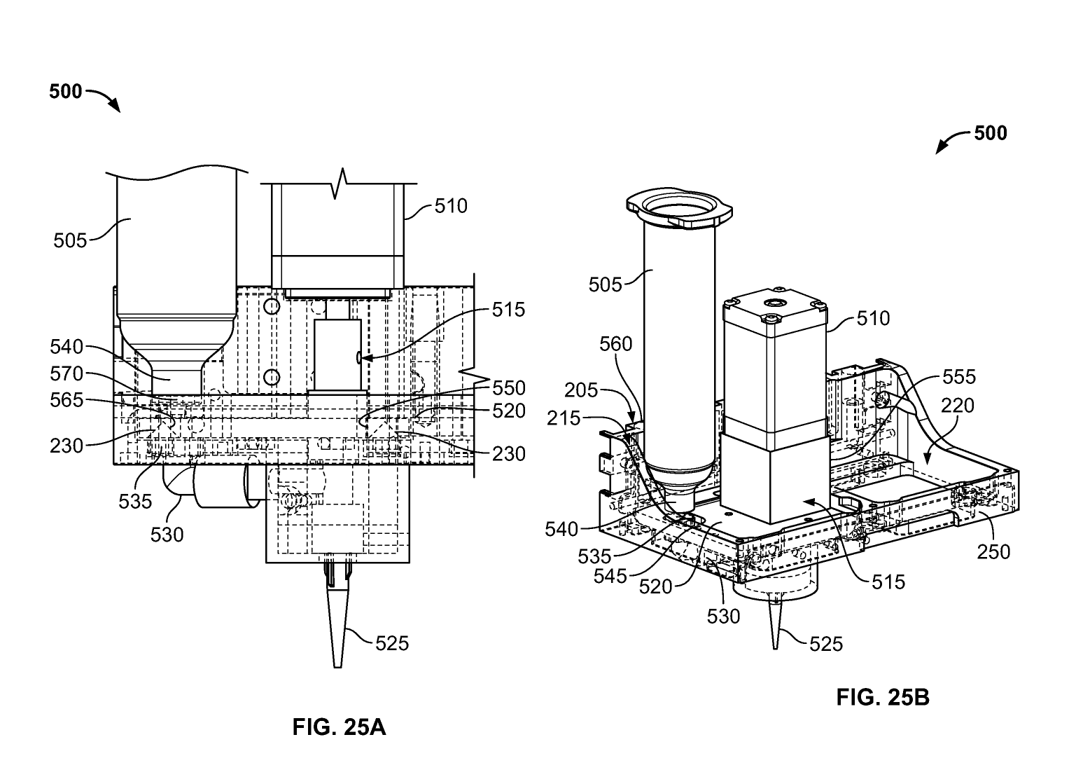

In some implementations, referring to FIG. 17, the PCB controller 240 may be removably attached, e.g., using screws 295, to the base portion 225 of the cartridge holder 250. In some variations, the cartridge controller 240 is in electrical and electronic communication with a plurality of sensors and electrical and electronic contacts, e.g., status pins 285 and/or status pin contacts 280. Advantageously, the PCB controller 240 is adapted to request and to receive cartridge information signals from an inserted cartridge 205, 210, e.g., via the status pins 285 and/or status pin contacts 280, and to provide the cartridge information to a main controller 14, e.g., via a dedicated status pin (Sig2) 206 (FIGS. 24 and 25). These cartridge information data signals enable the main controller 14 to tune and adjust the build process for any material disposed in a cartridge 205, 210, e.g., by controlling and adjusting the pulse width modulation (PWM) of the duty cycle of the cartridges solenoid, heater, etc. whenever a cartridge 205, 210 is installed or replaced. More particularly, in some applications, the main controller 14 executes slicer hardware/software to construct a computational model of each slice or layer of the 3D-printed object throughout the entire 3D printing process. Using cartridge information provided during on-going 3D printing, the slicer executed on the main controller 14 may adjust printer parameters, e.g., nozzle temperature, layer height, in-fill patterns, maximum speed, maximum acceleration, and so forth, taking into account properties of the build materials, e.g., material properties, material (remaining) quantity, temperature of build material, and the like, as well as operating properties of the cartridge 205, 210, e.g., nozzle diameter, ambient temperature, an error state, cartridge serial number, and the like.

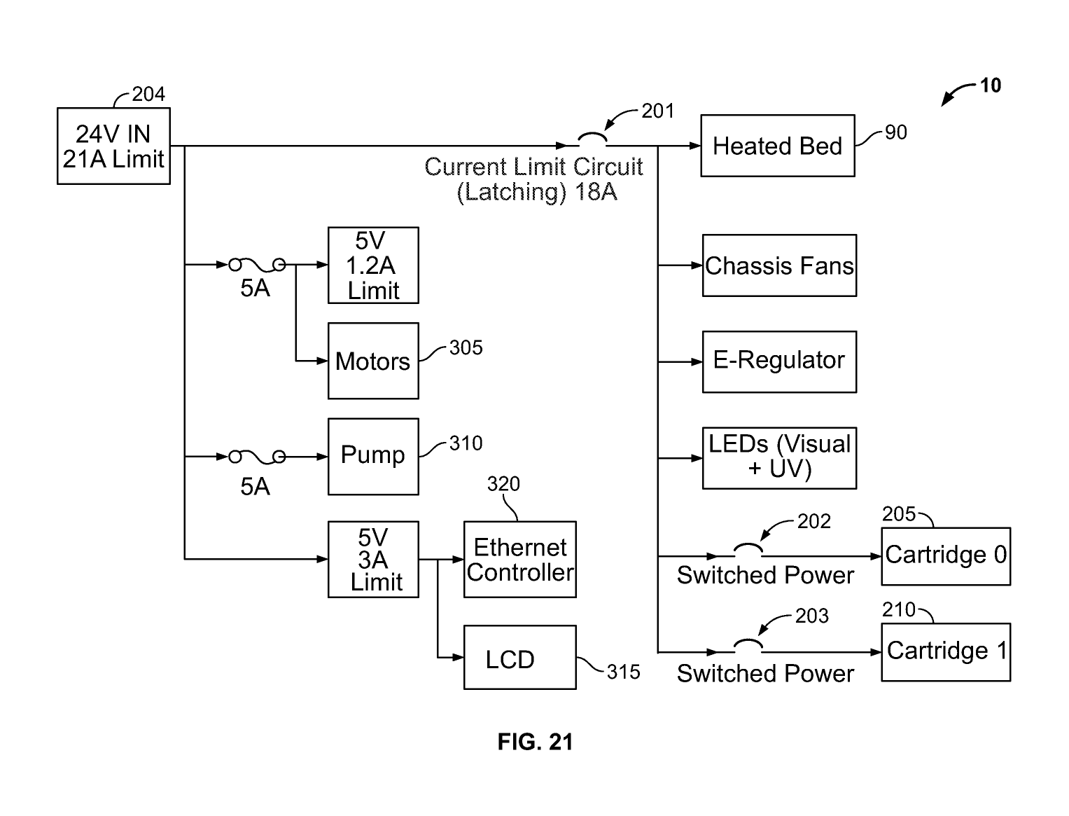

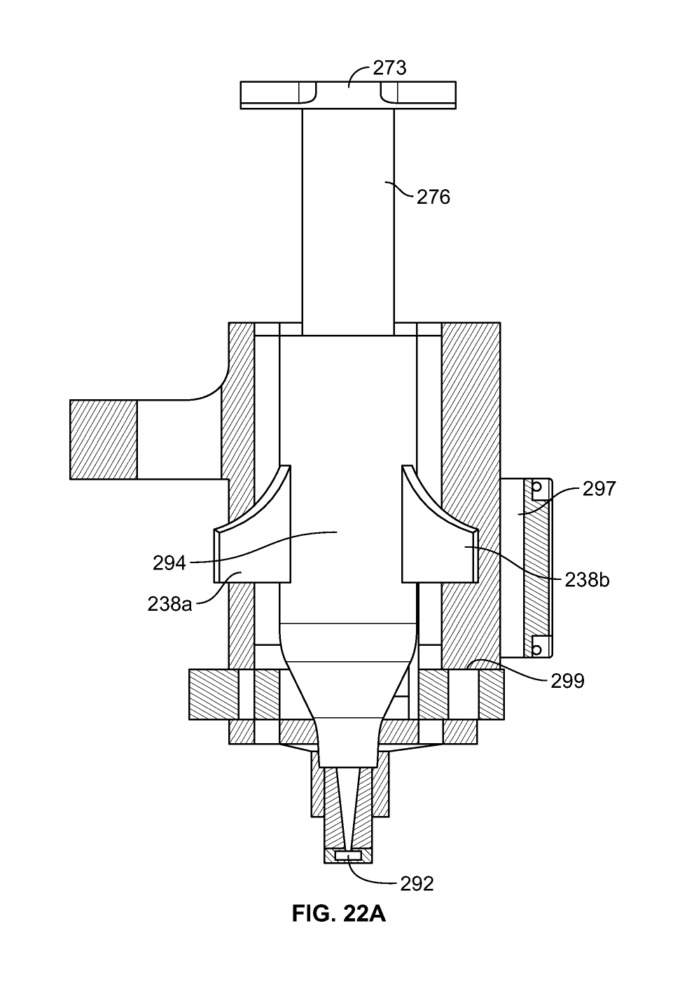

The plurality of sensors and electrical and electronic contacts also provide circuit protection that enables a user to remove cartridges 205, 210, as well as the build surface 90, safely while the 3D printer 10 is powered on. For example, referring to FIG. 21, one of the sensors may be a current monitoring (or limiting) circuit 201 that monitors current to the 3D printer 10 and/or to each cartridge 205, 210. Although FIG. 21 shows a single current monitoring (or limiting) circuit 201 between a power source 204 and the 3D printer 10, those of ordinary skill in the art can appreciate that current monitoring (or limiting) circuits 201 may be installed to each component of the 3D printer 10.

In instances in which the measured current exceeds a reference (maximum allowable) current, e.g., greater than about 18 Amps, the sensor(s) 201, after comparing the measured current to the reference current, may generate a signal to the PCB controller 240 and/or to the main controller 14, to shutoff the power to the 3D printer 10 and/or to one or more cartridges 205, 210. For example, a latch 201 may be used to interrupt power to the 3D printer 10 and switches 202, 203 may be used to shutoff power to the cartridges 205, 210. Hence, for example, if a cartridge 205, 210 is removed, closely monitored cartridge status will quickly, e.g., within about 50 μs, shutoff current to the removed cartridge 205, 210. In some implementations, a similar system circuit protection system may be incorporated in or with the heated build surface 90.

A plurality of, e.g., three or four, steel ball bearings 235 may be disposed at discrete locations on the PCB controller 240 for kinematically coupling the PCB controller 240 to the bottom of a corresponding cartridge 205, 210, and, more specifically, for kinematically coupling each of the steel ball bearings 235 in a corresponding slot or groove 230 formed in the base portion 260 of a replaceable cartridge 205, 210. Advantageously, magnets 290b or magnetic material may be formed in each corner of the PCB controller 240 for magnetically coupling the PCB controller 240 to the bottom of a corresponding cartridge 205, 210. In some variations, a corresponding plurality of magnets 290a are formed in the corners of the bottom of a corresponding cartridge 205, 210. Although the opposing magnets 290a, 290b induce an attractive force to keep the PCB controller 240 proximate to the bottom of a corresponding cartridge 205, 210 (and to preserve and promote the kinematic couplings), the magnets 290a, 290b do not have to make contact with one another. As an alternative to magnets, clamps, clasps, or other mechanical retention elements may be used.

The PCB controller 240 may include a plurality of contact points (or connections) 280 that are formed in the PCB controller 240 to be in registration with a corresponding plurality of contact, e.g., spring-loaded electrical, pins 285 formed in the bottom of a corresponding cartridge 205, 210. The contact points 280 and contact pins 285 provide electrical and electronic communication to the main controller 14 and between the PBC controller 240 and the cartridge 205, 210, when the two are properly align and coupled together. For example, the contact points 280 and contact pins 285 transmit power (current), control signals, and sensor and other data signals between the main controller 14, the PBC controller 240 and the corresponding cartridge 205, 210.

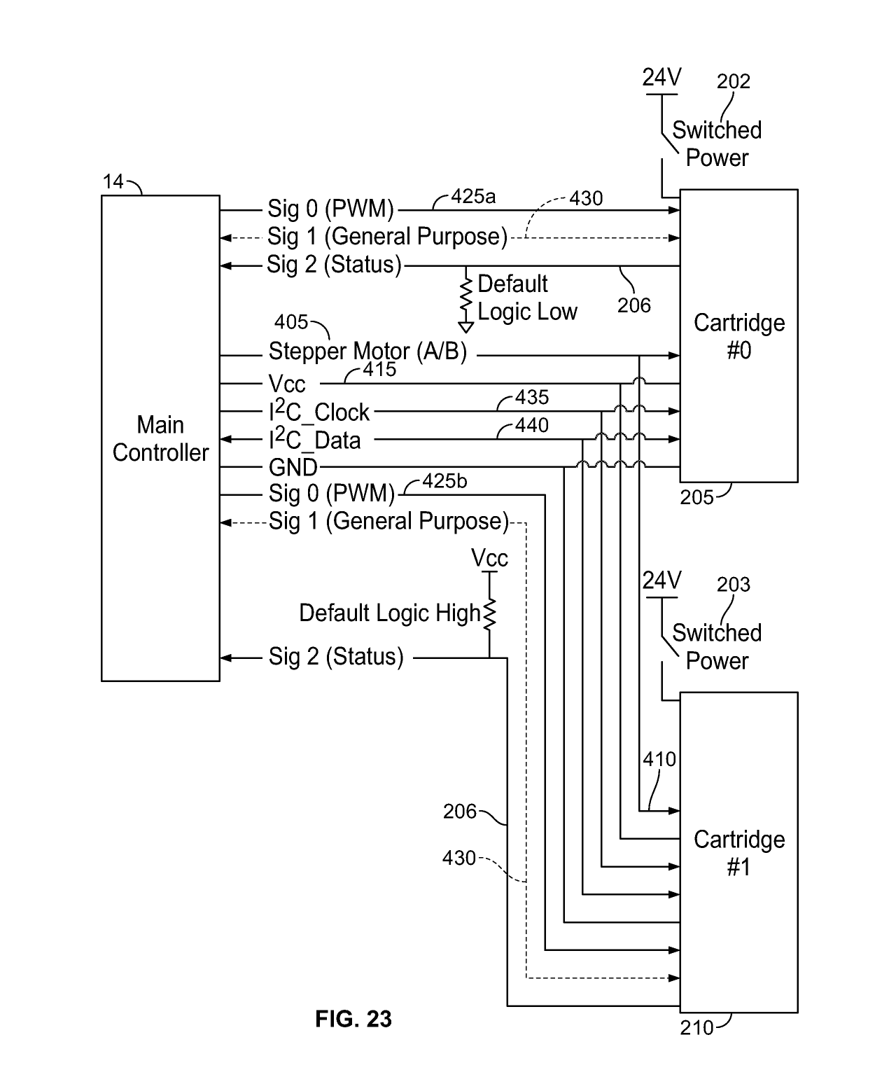

FIG. 23 depicts exemplary cartridge architecture and FIG. 24 depicts an exemplary 2×8 array 400 of status contact pins/status pin contact points formed on the PCB controller 240 in accordance with some embodiments of the present invention. In some variations, a similar (mirror-image) array of corresponding status contact pins/status pin contact points may be formed on the bottom surface of each cartridge 205, 210. The contact pins 285 and contact points 280 may be of the magnetic- or mechanical-type described in copending patent application Ser. No. 14/984,664, entitled “ELECTRICAL COMMUNICATION WITH 3D-PRINTED OBJECTS,” filed on Dec. 30, 2015.

For example, pins 1 and 2 405 of the array 400 may be dedicated to turning on and off a first stepper motor (A), while pins 3 and 4 410 of the array 400 may be dedicated to turning on and off a second stepper motor (B). Pin pair 5 and 6 415 and pin pair 7 and 8 420 may provide electrical communication to a power, e.g., 24V, source and ground, respectively. Pin 9 (Sig 0) 425 may be dedicated to controlling the PWM of the duty cycle of the corresponding cartridge 205, 210. For example, because the main controller 14 knows what the build materials and the printing components are for a given cartridge 205, 210, the main controller 14 will know to adjust the duty cycle 425a of a heater in cartridge 0 205 (for a structural filament) and to adjust the duty cycle 425b of a solenoid in cartridge 1 210 (for a functional ink).

Pin 10 (Sig1) 430 may be used as a general purpose connection through which the main controller 14 requests data from each cartridge 205, 210. Pins 11 435 and 12 440 may be used as an Inter-Integrated Circuit (I²C) bus for data lines (SDA 435) and a bus with a clock (SCL 440), respectively. Pin 13 206 may be used as a connection through which each cartridge 205, 210 provides responses and data to the main controller 14. Pin 14 445 may provide electrical communication between a low voltage, e.g., 5V, power source and the PCB controller 240. Pins 15 450 and 16 455 may be used to receive data from on-board thermistors.

Advantageously, the arrays of contact pins 285 and corresponding contact points 280 can provide signal and information data to the PCB controller 240 and the main controller 14 that identifies the specific cartridge 205, 210 and the associated build material dispensed by the cartridge 205, 210. In some implementations, the mating of contact pins 285 and discrete contact points 280 establishes an electronic handshake between the two devices. Absent a handshake that identifies the coupled device 205, 210, hardware of software associated with the main controller 14 would prevent using the unidentified cartridge 205, 210 in the desired 3D printing.

The build surface 90 is preferably disposed below the dispensing system 200, with the multi-axis positioning system adapted to position the dispensing system 200 relative to the build surface 90 in (x,y,z) space reliably and repeatably.

Referring to FIGS. 15B and 16, in some embodiments, the cartridge holder 250 includes a plurality of cartridge slots 215, 220 that are dimensioned to hold and retain corresponding removable and replaceable cartridges 205, 210. Grooves and/or corresponding protrusions may be formed on the walls of the cartridge slots 215, 220 and on the cartridges 205, 210 to prevent cartridges from going into the wrong slot 215, 220 or going into a slot 215, 220 misoriented. The cartridge slots 215, 220 may be structured and arranged to accommodate a specific cartridge type or may include a generic design capable of accommodating any cartridge type. Some portion of the base 225 of each cartridge slot 215, 220 includes an opening or aperture so that build materials and printing nozzles, tips, and the like may be precisely applied on or about the build surface 90.

In some embodiments, the cartridges 205, 210 themselves are dimensioned to fit snugly within a slot 215, 220. In addition to the components describe above for kinematically coupling the cartridge 205, 210 in a precise orientation within the slot 215, 220 and for electrically and electronically coupling the cartridge 205, 210 to the PCB controller 240 (and to the main controller 14), the structure of the cartridges 205, 210 includes components needed to support 3D printing of a discrete build material. Accordingly, cartridges 205, 210 can vary appreciably as a function of the build material.

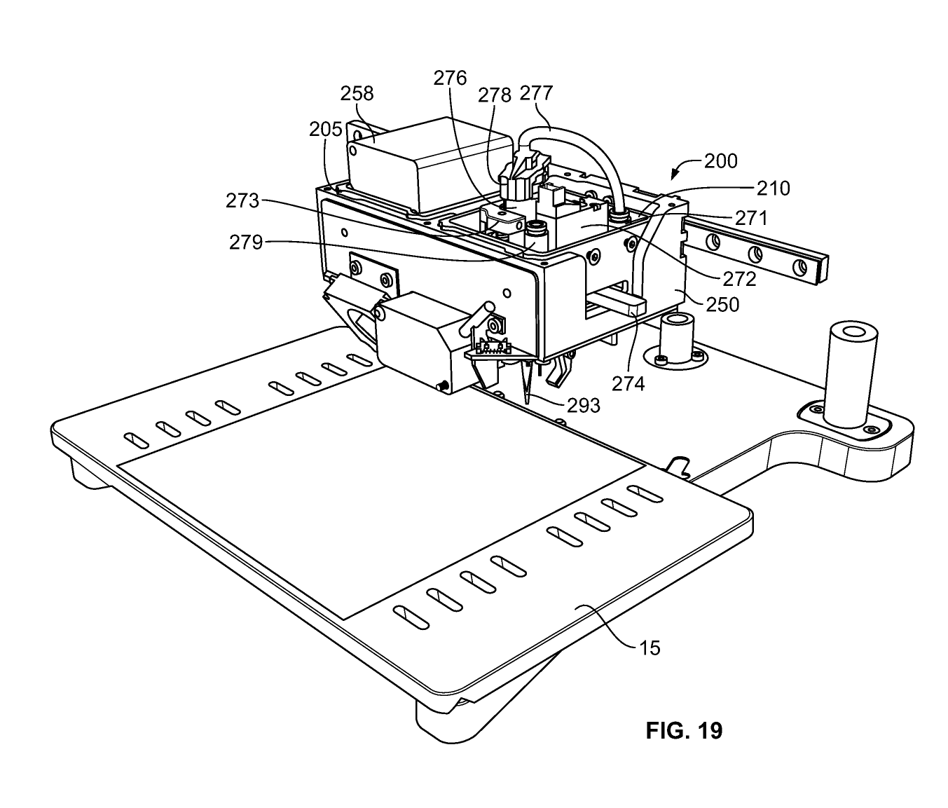

Referring to FIG. 19, an illustrative embodiment of a multi-cartridge dispensing system 200 for dispensing both a structural material and a functional material is shown. For example, one of the removable cartridges 205 may be structured and arranged for extruding a structural material, e.g., a filament (e.g., a polymer, a composite, a ceramic, FFF, and so forth). A second cartridge 210, e.g., a pneumatically controlled cartridge, a volumetric dispensed cartridge (e.g., an auger-type system, a syringe pump, and the like), and/or a hybrid system having both an auger-type system and a pneumatically controlled cartridge, may be adapted for dispensing a material at or near room temperature, e.g., a functional ink. The functionality of the ink may include, for the purpose of illustration and not limitation, conductive, magnetic, dielectric, insulative, semiconductive, and so forth. Although this disclosure will describe a pneumatically controlled cartridge 210 in connection with dispensing a functional ink, in other implementations, the cartridge may also dispense a matrix ink, such as epoxy, thermoplastics, silicones, or combinations thereof and/or the cartridge may be a volumetric dispensed cartridge (e.g., an auger-type system, a syringe pump, and the like), and/or a hybrid system having both an auger-type system and a pneumatically controlled cartridge.

Exemplary functional inks include metal nanoparticle inks, such as the inks described in U.S. Pat. No. 7,922,939, which is incorporated herein by reference its entirety. For example, in a specific implementation, the functional ink may include stabilized silver particles. Stabilized silver particles are silver particles that preferably have a mean particle size of 5-500 nm, more preferably 10-50 nm, for example 15-25 nm, including 20 nm, which are stabilized by an adsorbed short-chain capping agent and an adsorbed long-chain capping agent. The capping agents may be polymers containing anionic and/or acidic repeating units, preferably carboxylic acid and/or carboxylate moiety containing repeating units, such as poly(acrylic acid), poly(methacrylic acid), copolymers thereof and salts thereof. These polymers are referred to as anionic polyelectrolytes, which include both the anionic and protonated forms. Examples of anionic polyelectrolytes includes poly(acrylic acid), poly(methacrylic acid), poly(methyl methacrylate), poly(lauryl methacrylate), carboxymethyl ether, carboxyl terminated poly(butadiene/acrylonitrile), poly(butadiene/maleic acid), poly(butyl acrylate/acrylic acid), poly(ethylene glycol)monocarboxymethyl ether monomethyl ether, poly(ethylene/maleic acid), poly(maleic acid), poly(methyl methacrylate/methacrylic acid), poly(vinyl methyl ether/maleic acid), poly(vinyl methyl ether/monobutyl maleate), poly(vinyl methyl ether/monoethyl maleate), poly(vinyl methyl ether/mono-iso-propyl maleate), copolymers thereof and salts and mixtures thereof. The anionic polyelectrolytes, such as poly(acrylic acid) [(CH₂C(O)OH)ₙ, PAA], is used not only as a stabilizing agent but also as a binder, providing adhesion of inks on the substrates. The steric stabilization and multiple capping by the anionic groups, such as carboxyl (—COOH) groups from the PAA, provide long lifetime stability for the inks.

The short-chain capping agent has a molecular weight (Mw) of at most 10,000, such as between about 1,000 and about 10,000, preferably between about 2,500 and about 7,500, and more preferably between about 4,000 and about 6,000. The long-chain capping agent has a molecular weight (Mw) of at least 25,000, such as between about 25,000 and about 100,000, preferably between about 30,000 and about 80,000, and more preferably between about 40,000 and about 60,000. The weight ratio of the short-chain capping agent to the long-chain capping agent is preferably between about 5:95 and about 95:5, including between about 10:90 and about 90:10, and between about 20:80 and about 80:20.

In some applications, the silver particle ink contains stabilized silver particles dispersed in an ink solvent. The ink solvent preferably contains water, and more preferably also contains a non-aqueous solvent which is soluble in water and has a higher boiling point than water, such as polyols, (e.g., ethylene glycol, propylene glycol and glycerin). Preferably, the ink solvent contain a weight ratio of water:non-aqueous solvent of between about 5:1 to about 1:5, more preferably between about 3:1 and about 1:3. Preferably, the silver particle ink has a silver content (solid loading of metallic silver as weight percent of the composition) of at least about 50 wt %, more preferably at least about 60 wt %, and most preferably at least about 70 wt %, such as between about 70 and about 85 wt %, including about 75 wt %, about 77 wt %, and about 82 wt %. The silver particle ink is shear thinning, i.e., apparent viscosity decreases with increasing shear rate. Furthermore, the silver particle ink has elastic (G′) and viscous (G″) moduli, such that G′≧1.5 G″. Exemplary silver particle inks are stable for at least two months at room temperature and are readily re-dispersible in water or ethylene glycol.

In some embodiments, the conductive material may include conductive particles dispersed in a solvent. The conductive particles may be conductive flakes, such as silver flakes. Alternatively, the conductive particles may have another morphology, such as rods, spheres, polygons, tubes, needles, and so forth. Exemplary conductive particles include: silver polygons and nanorods, gold nanorods, silver-coated copper particles, silver-coated copper flakes, silver-coated copper rods, tin particles, nickel particles, aluminum particles, insulating particles coated with conductive coatings, graphene, graphite, carbon black, carbon nanotubes, conductive polymer particles, and pure copper particles that may be packed with an appropriate reducing agent to prevent surface oxidation.

The solvent for the conductive ink formulation may be selected to promote formation of a strong bond between the conductive filament and the underlying substrate—which may be the structural material of the 3D-printed object—upon drying. The solvent may be capable of dissolving a surface layer of the structural material, so that portions of the conductive ink that come into contact with the 3D-printed object may strongly adhere upon drying. Further exemplary criteria for suitable functional inks may be found in International Patent Application Publication WO 2014/209994, which is incorporated herein in its entirety by reference.

One of the removable cartridges 205 may be structured and arranged for extruding a filament, e.g., a fused filament fabrication (FFF)/matrix material. The filament may be made of a polymer, a composite, and/or a ceramic. The FFF cartridge 205 pushes or pulls a material, such as a thermoplastic, e.g., ABS, PLA, or ULTEM thermoplastic-based filament, through a hot end, e.g., an E3D V6 hot end, at the dispensing tip 293. The hot end heats up the filament and then the multi-axis positioning system 70 moves the heated filament relative to the build surface 90 so that it dispenses in a programmed geometry to create the printed object.

The FFF delivery system can be implemented with an extruder, e.g., a D3D HPX1 v4 extruder manufactured by Dglass 3D Inc., pushing a thermoplastic filament 1 mm-10 mm in diameter from next to the filament spool, in the middle, or right near the hot end. For example, a direct drive system proximate the hot end, a Bowden (Nema 23 or other sized motors for torque) system, and the like may be used, allowing the motor to be located, referring to FIG. 14, next to the filament spool 140 in the base of the 3D printer 10 and not moving on the XY stage.

Referring to FIG. 14, a FFF spool 140 may be placed beneath the build surface 15, on a, e.g., rotatable, post 146 within the base 145 of the 3D-printer 10. Spools 140 are well-known to the art and, typically include a center cylinder 143 about which the FFF is wrapped and a pair of opposing flanges 142 that provide some confinement to the FFF.

Typically, FFF is wound around a center cylinder 143 having an inner diameter slightly larger than the outer diameter of the post 146 to provide a snug fit between the post 146 and the center cylinder 143. In some variations, the post 146 is tapered, such that the outer diameter of the rotatable post 146 decreases, at a uniform rate, from a bottom, proximal end to a top, distal end of the center cylinder 143. Having a tapered post 146 ensures that the center cylinder 143 of the spool 140 fits snuggly on and is supported by the post 146, so that, rotation of the post 146 will cause the spool 140 to rotate as well. In some implementations, the center cylinder 143 has a constant inner diameter or a tapered diameter that decreases consistent with that of the post 146.

Alternatively, in other variations, the post 146 may be fixed about a rotating disk, e.g., a spool holder, that supports one of the flanges 142, as well as the spool 140, so that, rotation of the disk will cause the spool 140 to rotate as well. Whether the post 146 or the disk rotates, a small amount of friction or drag on the post 146 or the spool holder can ensure appropriate tension on the filament during extrusion out of the cartridge during a build cycle.

Referring to FIGS. 16 and 18-20, the FFF/matrix cartridge 205 is readily and safely insertable and removable from at least one of the cartridge slots 220 in the cartridge holder 250 of the dispensing system 200. Because, inter alia, of the high heat associated with heating the filament, the cartridge 205 may include a cover 258. In some implementations, the FFF/matrix cartridge 205 includes a heating device for heating the FFF filament to a desired temperature, a first fan 262 for cooling the cartridge 205, and a second fan 264 that is in fluid communication with a fan shroud 275 for cooling the extruded, hot end of the filament. The free-running end of the FFF passes through the cartridge 205, exiting the cartridge 205 and the cartridge holder 250 via a hollow dispensing tip, nozzle or other aperture device 252. The hollow dispensing tip, nozzle or other aperture device 252 is structured and arranged to accurately deliver the extrudable material via a distal end 254. The dimensions of the openings at the distal end 254 and of the hollow dispensing tips or nozzles 252 may vary depending on the material being extruded and the necessary precision of the build object.

In some variations, a holding device 256 may be provided for retaining a readily insertable and removable heating device. Preferably, the holding device 256 is structured and arranged to include a heater entry opening 257 that is dimensioned to provide a snug fit with the heating device when inserted. Preferably, the holding device 256 is made of a thermally conductive material to transfer heat from the heating device, e.g., by conduction, to the dispending tip or nozzle 252 and the hot end of the filament.

At least one of the cartridges 210 may be a pneumatically controlled cartridge, a volumetric dispensing cartridge (e.g., an auger-type system, a syringe pump, and the like), and/or a hybrid system having both an auger-type system and a pneumatically controlled cartridge. Although embodiments of the invention will be described as having a pneumatically controlled cartridge, that is done for illustrative purposes only. Those of ordinary skill in the art may adapt the teachings herein to use a volumetric dispensed cartridge (e.g., an auger-type system, a syringe pump, and the like), and/or a hybrid system having both an auger-type system and a pneumatically controlled cartridge The pneumatically controlled cartridge(s) may be adapted for dispensing a material at room or ambient temperature, e.g., a functional ink including conductive, magnetic, dielectric, and/or semiconductive materials. The pneumatically controlled cartridge may also dispense a matrix ink, such as epoxy, thermoplastics, silicones, or combinations thereof.

Referring to FIGS. 19-21, in some embodiments, the second cartridge 210 is pneumatically controlled and structured and arranged for receiving a conventional, removable and refillable syringe 276. The pneumatic system is configured for driving a functional and/or a structural material, e.g., at or near room or ambient temperature, from the syringe 276 onto the build surface 90. Build material capacities (volumes) of the syringe 276 may range from about 0.1 mL to about 1 L. In some embodiments, both cartridges 205, 210 are pneumatically controlled, allowing the dispensing of both functional and matrix or structural inks and/or other room temperature dispensable materials.

In some embodiments, the cartridge 210 includes a syringe holder 294, a z-axis positioning device 232, a solenoid 272 and/or a servo-motor 297, and a plurality of sensors. The 3D printer 10 includes a compressor/pump 310, a fluid storage tank, a regulator, which are disposed within the base of the 145 (FIG. 14) of the printer 10. In some implementations, the compressor/pump 310 is capable of compressing a fluid, e.g., a gas, air, and the like, to a pressure greater than about 100 psi. The fluid storage tank acts as a fluid reservoir and may contain a fluid volume of up to about 1 L.

In some implementations, the pneumatic system may also include a first sensor, e.g., a pressure transducer, to monitor the pressure of the compressed fluid in the storage tank. Preferably, the transducer is disposed inline and downstream of the storage tank and, more particularly, is electronically coupled to the main (system) controller 14 to generate and transmit pressure data signals to the main controller 14. Advantageously, if the compressed fluid pressure level drops below a predetermined level, then the main controller 14, after receiving pressure data signals from the transducer, is adapted to execute a driver program that turns off the compressor/pump 310 until the main controller 14 receives pressure data signals, indicating that the compressed fluid pressure level is above the predetermined level. The main controller 14 can include hardware as well as a software algorithm or a combination thereof.

In some implementations, the regulator may be placed inline and downstream of the storage tank, the pressure transducer, and the compressor. The regulator may be configured to reduce the pressure that the pneumatic dispense head 278 receives, which may be in a range of about 0.1 psi to about 100 psi. The regulator can be either manually controlled, e.g., via with a knob directly adjusting the pressure, or via an electro-pneumatic regulator that is automatically controlled.

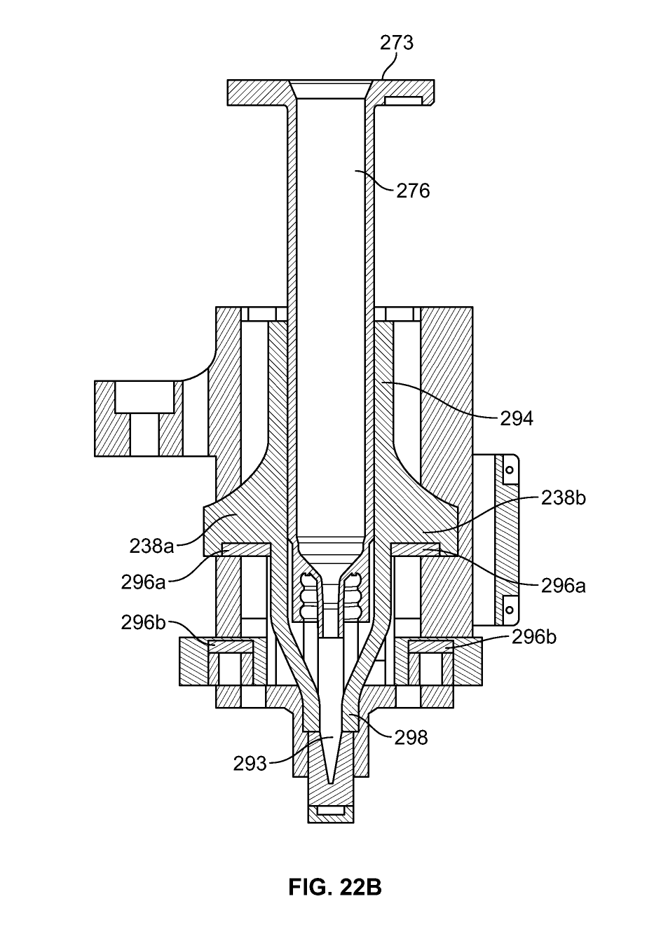

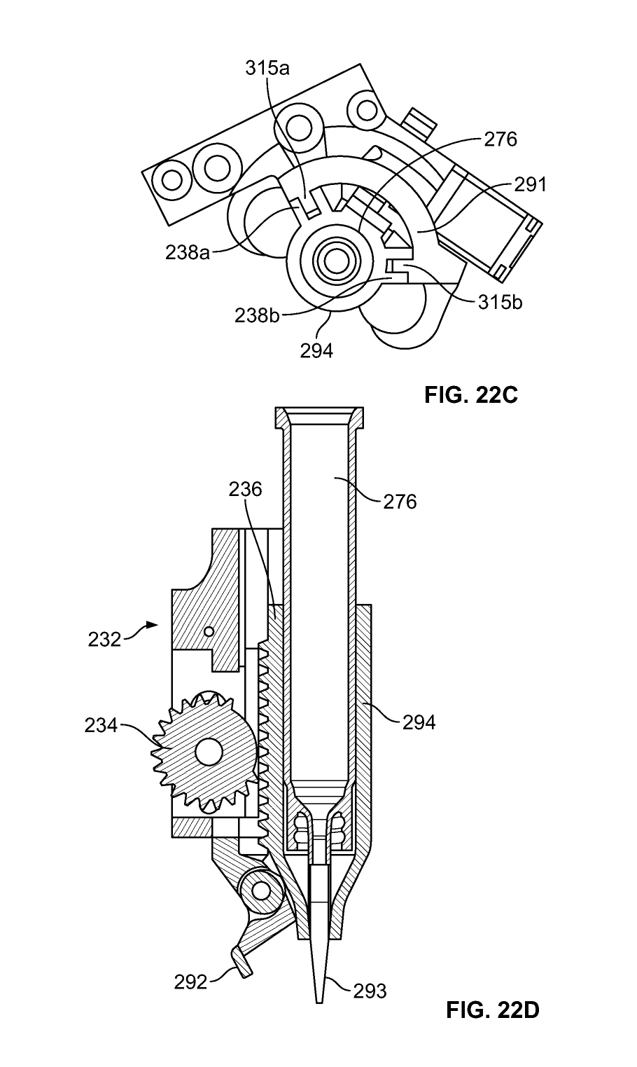

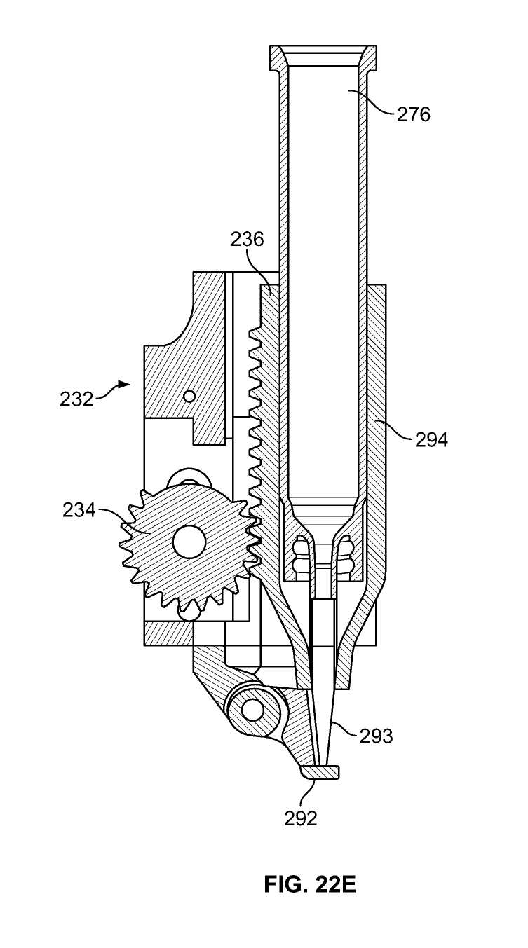

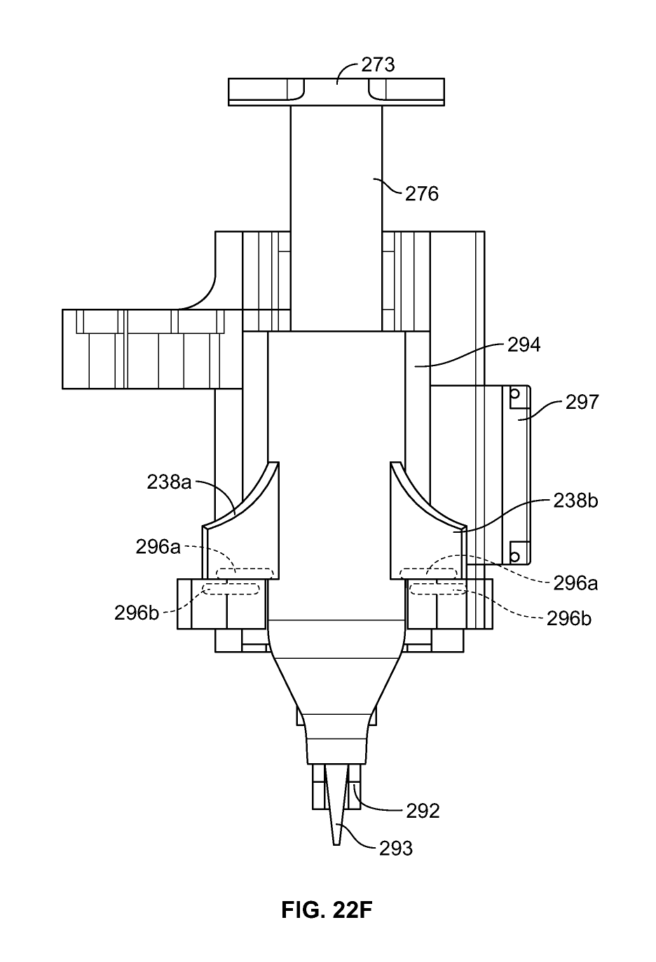

In operation, in one implementation, actuating and capping the syringe 276 may be implemented as follows. First, the syringe 276 may be introduced into the syringe holder 294 and properly seated. Referring to FIGS. 22A-22C, the outer diameter of the syringe 276 may be the same or slightly greater than the inner diameter of the syringe holder 294 to provide a friction fit between the two. In some variations, pairs of tracks or wings 238a, 238b are formed on the syringe holder 294 to properly align the syringe 276 with respect to the syringe holder 294. For example, referring to FIG. 22C, a pair of elongate guides 315a, 315b may be formed on a guide key 291 of the syringe holder 294. In one application, the thickness of the elongate guides 315a, 315b is the same or slightly less than the gap between each of the pairs of tracks or wings 238a, 238b, so that the pairs of tracks or wings 238a, 238b and the syringe holder 294 slide along the elongate guides 315a, 315b to their desired position.

In some implementations, a magnet 296a or a magnetic material is formed on the bottoms of each of the pairs of tracks or wings 238a, 238b. A corresponding pair of magnets 296b or a magnetic material is formed on the hard stop base 299 of the cartridge 210. The polarities of each magnet pair 196a, 296b are opposite, so that the paired magnets 296a, 296b attract, holding the syringe holder 294 securely in place within the cartridge 210 (FIG. 22A). Advantageously, the magnetic lock and registration system avoids jitter in the syringe 276 when the servo-motor 297 is operating and also ensures that repositioning of a removed syringe 276 is reliably repeatable.

At a distal end of the syringe holder 294, an opening or aperture 298 is formed. The inner diameter of the opening 298 is slightly greater than the outer diameter of a syringe nozzle 293 that is in fluid communication with the inside of the syringe 276.

When not in use, the nozzle or tip 293 of the syringe 276 in the cartridge 210 may be capped, since the material inside can dry out or degrade if exposed to the environment. Capping can be mechanically linked to a downwards activation mechanism 232 described below, or it may have its own automatic capping mechanism. The capping can be made of a gasket-like material that the pneumatic nozzle tip 293 gets pressed against to create an air-tight seal.

In some embodiments, the pneumatically controlled cartridge 210 may include a capping arm 292 that caps and uncaps the dispensing tip automatically, by pivoting of the biased, e.g., spring loaded, capping arm 292, as depicted in FIGS. 22D and 22E, due to vertical, i.e., z-axis, movement of a rack and pinion driven syringe holder 294. For example, a biased capping mechanism 292 may be disposed proximate the nozzle 293, so that when the syringe 276 is properly inserted into the syringe holder 294 and the syringe holder 294 is lowered to an actuation position (FIG. 22D), the capping mechanism 292 is forced to travel along an outer surface of a tapered portion at the distal end of the syringe holder 294. In some variations, a spring, a rubber band, and the like may be used to bias the capping mechanism 292 to resist the advancing tapered portion. Due to the biasing, when the syringe holder 294 is raised from the actuation position (FIG. 22E) and the tapered portion is withdrawn, the capping arm 292 returns to its at-rest position (FIG. 22E), such that the distal end of the syringe nozzle 293 finally rests on a lower portion of a capping arm 292 and the distal end of the syringe holder 294 finally rests on an upper portion of the capping arm 292. Advantageously, the capping mechanism 292 covers the retracted dispensing tip 293, to prevent build material from drying out and clogging the tip.

The main controller 14 of the pneumatic system may actuate the nozzle of tip 292 of the syringe 276 downwards (about 10 mm) beneath the matrix material/FFF cartridge dispensing tip 254. This solves many problems with dual nozzle printing, i.e., it allows the pneumatic controlled material to be dispensed into holes, and helps prevent print failure by making sure the material dispensing tips do not contact any portion of the object that may be warping or otherwise interfering with the printing operation.

The pneumatic system can be actuated downwards in a variety of methods, such as mechanically, (e.g., using a DC motor, a stepper motor, a servo-motor 297, an electromagnet, a solenoid, a differential air pressure, and the like), hydraulically, manually, or using the FFF filament. The syringe 276 may also be actuated downwards with a mechanical mechanism activated by a movement in the z-axis. For example, with a hook mounted on the build platform 90, after a series of movements of the printer head, downward travel in the z-axis engages the hook, pulling the pneumatic controlled cartridge downwards. The hook may then be used to push the pneumatically controlled cartridge back into place when done, by reversing the procedure.

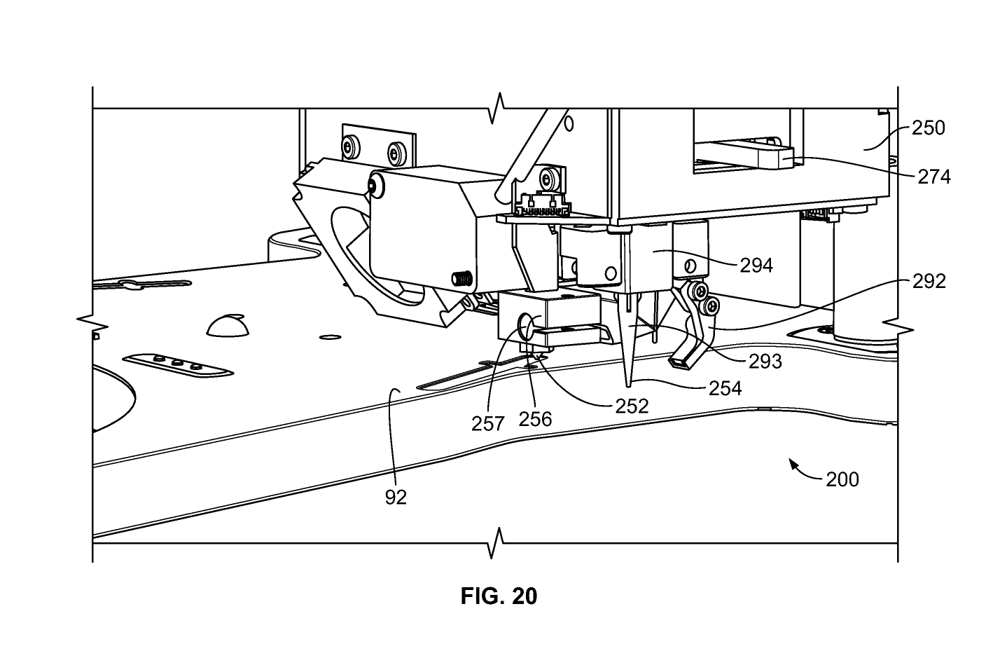

As shown in FIGS. 22D and 22E, in some implementations, a rack and pinion system 232 may be used for vertically translating the syringe holder 294, e.g., in the z-direction. For example, a circular pinion 234 may include a plurality of teeth about its outer, peripheral surface, as well as a flat, smooth, or non-toothed portion that is adapted for suddenly releasing the rack 236, when the syringe holder 294 is displaced in a downward position. As previously described, once the syringe holder 294 is released, magnet pairs 296a, 296b may be provided on each of the wings 238a, 238b of the syringe holder 294 and the cartridge 210 to allow the repeatable positioning of the syringe holder 294 within the pneumatically controlled cartridge 210, once the pinion 234 disengages from the rack 236. The rack and pinion system 232 may also be driven automatically via the main controller 14 or manually via a lever 274 (FIGS. 19 and 20).

When 3D printing using the pneumatic cartridge 210, the main controller 14 controls the operation of the various components, e.g., the pump 310, the servo-motor 305, etc., of the cartridge 210 to deliver, e.g., extrude, a functional or structural material that, in certain applications, occurs at or near room or ambient temperatures. As shown in FIG. 19, for the purpose of illustration and not limitation, a measured amount of a (electrically conductive silver) functional ink may be placed in the syringe 276. Optionally, a volume sensor(s) may be disposed inside or outside of the syringe 276 to determine the volume of silver in the syringe 276 and to generate and transmit build material volume data signals to the main controller 14 by methods that are well-known to those of ordinary skill in the art. Indeed, volume sensors may be used to detect the amount of build material left in each pneumatically dispensed cartridge 210. For example, the sensors can be implemented using optical sensors, such as an optical distance sensor to measure the location of the syringe plunger 273, flow rate sensors to measure the flow rate of material extruded out of the cartridge 276, Hall effect/magnetic sensors, with which a moving plunger 273 triggers the sensor as the plunger 273 passes by the sensor (for an empty cartridge), or air flow sensors that measure how much compressor air is exiting the evacuated syringe 276. For example, the more air that exits the syringe, the emptier the cartridge is.

In some embodiments, the cartridge holders 250 may include a sensor, e.g., an induction sensor, for sensing a (x,y) location and/or an (x,y,z) orientation with respect to the build surface 15.

In another embodiment, the removable cartridges 205, 210 may be structured and arranged to accommodate a volumetric-type dispenser. For example, referring to FIGS. 25A and 25B, a cartridge 205 having an auger dispensing system 515 is shown. In some implementations, the cartridge 205 includes a base portion 520 and a wall portion 560 that are fixedly attached to each other or are monolithically manufactured. Although FIG. 25B shows only a single wall 560, in other variations, the cartridge 205 may include a plurality, e.g., 2, 3, or 4, walls 560.

In some applications, the base portion 520 includes a plurality of, e.g., two, apertures 545, 550 and a plurality of slots or groove 230 are formed on the lower surface of the base portion 520 for kinematically coupling the cartridge 205 to the cartridge holder 250. In some variations, a first aperture 545 is structured and arranged for receiving a build material reservoir 505, e.g., a syringe and/or a coupling portion 535 of a conduit 530 and a second aperture 550 is structured and arranged for receiving an auger dispensing system 515.

In some implementations, a motor 510 may be disposed atop of auger dispensing system 515, in mechanical communication therewith. In operation, the motor 510 applies torque to the auger-dispensing system 515 to dispense a controlled volume of a build material via a dispensing tip of a nozzle 525. A cover 555 may be installed around the auger dispensing system 515. Optionally, the cover 555 may also be installed around the motor 510.

In some variations, the build material is introduced into the auger via a conduit 530 that may be structured and arranged above or below the base portion 520. A distal end of the conduit 530 provides fluidic communication with the auger dispensing system 515. A proximal end of the 530 includes a coupling portion 535 having an aperture 565 that provides fluidic communication between the conduit 530 and ambient.

The build material reservoir 505, e.g., a syringe, may be an elongate, hollow cylinder having an open end for introducing the build material into the build material reservoir 505 and, at the other end, a nozzle 540 with a dispensing tip 570. In some variations, the build material reservoir 505 may be in fluid communication with a larger reservoir via a pump that can automatically pump build material from the larger reservoir into the build material reservoir 505. The dispensing tip 570 is structured and arranged to provide a fluid-tight seal against the coupling portion 535 when the dispensing tip 570 is inserted into the aperture 565.

In operation, the main controller 14 controls the flow of build material from the build material reservoir 505 into the auger of the auger dispensing system 515, as well as the dispensing of the build material onto the build surface 90, e.g., via the nozzle 525. The flow may be a gravity flow or pressurized, e.g., using a plunger.

Electrical spring loaded pins, e.g., Pogo® pins, may be implemented to enable making a quick connection to cartridges 205, 210, as well as facilitate error detection, e.g., a disconnection due to absence or improper loading of a cartridge 205, 210. Proper loading is facilitated by magnets that hold down the cartridge 205, 210 in the cartridge slots 215, 220. To remove a cartridge 205, 210 from a cartridge slot 215, 220, a minimum force is required to overpower the magnets, which then disconnects the Pogo®-type pins. At that point, the electronics on the printer 10 may recognize that there is no electrical contact, and may indicate an error.

The 3D printer 10 includes several levels for ensuring that the right cartridge holder and the right build material have been inserted into the cartridge holder 250. For example, with a dispensing system 200 that includes a cartridge holder 250 that holds two or more removable cartridges 205, 210, each cartridge holder 205, 210 and each corresponding cartridge slot 215, 220 may be slotted differently for functional and/or structural materials, to help prevent the cartridges 205, 210 from being installed in a wrong cartridge slot 215, 220 or from being misoriented, e.g., installed backwards, in a proper cartridge slot 215, 220.

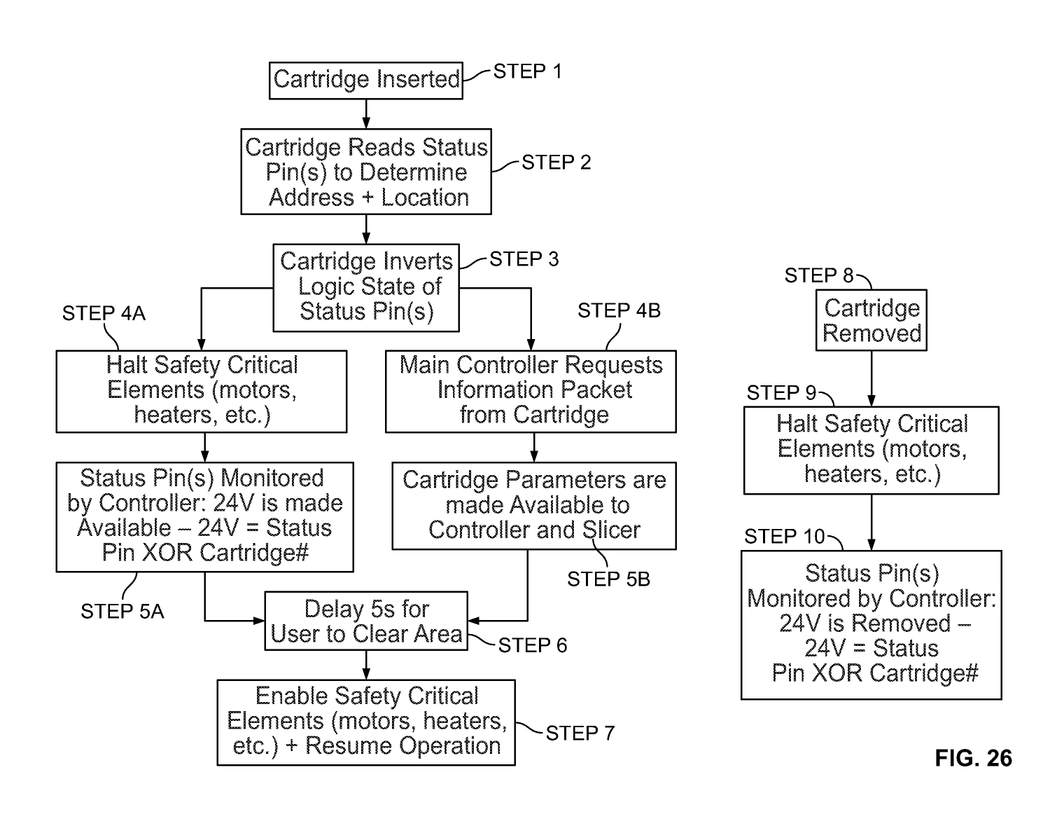

Advantageously, as a backup to provide another level of certainty, the 3D printer 10 and the dispensing system 200 are configured to provide an electronic handshake between the PID controller 14 and the individual cartridges 205, 210 at the time of their installation within discrete cartridge slots 215, 220. Referring to FIG. 26 an illustrative embodiment of a handshake method is shown. The handshake process begins when a cartridge is installed in a cartridge slot of a cartridge holder (STEP 1). As previously described, each cartridge may include a plurality of status pins, e.g., Pogo®-type pins, hence, once installed the cartridge is adapted to read the status pins to determine a unique address and location (STEP 2). The number of status pins required may be determined by the equation:

Number of pins=log₂(No. of cartridge slots).

In a subsequent step, the cartridge controller (PCB) inverts the logic state of the logic pins (STEP 3) so that safety critical components, e.g., motors, heaters, compressors, and the like, can be turned off (STEP 4A), while the main controller requests information from the cartridge (STEP 4B). In response to the request, the cartridge controller provides cartridge parameters to the main controller and the slicer (STEP 5B). Exemplary cartridge parameters may include, for the purpose of illustration and not limitation, all or any combination of the cartridge type, the build material, build material properties, build material quantity available, the syringe nozzle diameter, ambient temperature, an error state, a serial number, and so forth. The main controller monitors the status pins (STEP 5A) and the handshake is completed. Before operation resumes, however, typically a time delay (STEP 6), e.g., a few seconds, enables personnel to clear the area before the main controller turns back on the safety critical components, e.g., motors, heaters, compressors, and the like (STEP 7).

When a cartridge is intentionally or accidentally removed (STEP 8), safety critical components, e.g., motors, heaters, compressors, and the like, can be turned off (STEP 9). The main controller monitors the status pins (STEP 10), anticipating a new or the same cartridge to be installed in a cartridge slot of the cartridge holder (STEP 1) and the process continues once another cartridge is installed in a cartridge slot of the cartridge holder (STEP 1).

While the handshake is taking place, before or after the syringe 276 has been properly seated in the syringe holder 294, an air pressure adapter 278 may be fixedly and removably attached at or about the open end of the syringe 276. A fluid line or conduit 277 fluidicly couples the air pressure adapter 278 to an outlet of the solenoid fluid pressure valve 271. An inlet valve 279 receives compressed fluid via the compressor/pump from the fluid reservoir. The solenoid 272 causes compressed fluid to travel from the inlet valve 279 to the outlet valve 271 and then on to the syringe 276. Once the handshake has been completed, the solenoid 272 and the main controller 14 control the rate and magnitude of compressed fluid delivered to the air pressure adapter 278. The delivered compressed fluid forces the plunger 273 towards the nozzle or tip 292, extruding the build material at the desired rate.

For cleaning the nozzles or tips, two purge areas may be included in the stage area of the build surface 90: one stage area for the FFF system 205 and one stage area for the pneumatic dispensing system 201, or whatever build materials/cartridges are being used. Purges involve wiping each dispensing nozzle across silicone, metal wipers, and the like into purge containers. The purge containers and wipers can be either stationary or actuated. In one embodiment, the purge containers can be placed on either side of the z-axis support frame, in the necked down region, proximate the vertical rails 101 (FIG. 9A).

Optionally, the 3D printer may include a vacuum system for pick-and-place of components on the build surface and/or of the object being printed.

Table I (below) provides exemplary hardware, software, and consumables requirements.

TABLE I

| | | | |
|---|---|---|---|
| Reqt | | | |
| ID # | Feature | Typical Requirement | Min/Max Specs |

Section 1 Hardware Requirement

| | | | |
|---|---|---|---|
| 1.1 | Print Method | Fused Filament Fabrication | FFF, epoxies or other room |
| | | (“FFF”) | temperature materials |
| 1.2 | Build Volume | 10.16 cm × 15.24 cm × 10.16 cm | From 1 × 1 × 1 to 20 × 20 × 20″ |
| | | (4 in × 6 in × 4 in) | |
| 1.3 | Layer Thickness - | 150 microns | From 10 μm to 1 mm. |
| | Conductive Ink | | |
| 1.4 | Layer Thickness - | 150 microns | From 10 μm to 1 mm |
| | Filament | | |
| 1.5 | Trace Width - | 350 microns | From 10 μm to 1 mm |
| | Conductive Ink | | |
| 1.6 | Trace Width - | 350 microns | From 10 μm to 1 mm |
| | Filament | | |
| 1.7 | Print Speed - | 10 mm/sec | From 1 mm/sec to 1 m/s |
| | Conductive Ink | | |
| 1.8 | Print Speed - | 50 mm/sec | From 1 mm/sec to 1 m/s |
| | Filament | | |
| 1.9 | Print Speed - | 80 mm/sec | From 1 mm/sec to 1 m/s |
| | Nozzle Travel | | |
| | Speed | | |
| 1.10 | XY Positional | 15 microns | From 500 nm to 50 μm |
| | Precision | | |
| 1.11 | Z Positional | 15 microns | From 500 nm to 50 μm |
| | Precision | | |
| 1.12 | Structural | Print quality comparable to a | |
| | Characteristics of | consumer level FFF printed | |
| | Printed Parts | piece. | |
| 1.13 | Calibration | Auto-home each axis | |
| 1.14 | Print Bed | Planar and level to XY plane | |
| 1.15 | Connectivity | USB, Ethernet | |
| 1.16 | Electrical | 100-240 V, 50-60 Hz | |
| | Requirements | | |
| 1.17 | Weight | TBD | |
| 1.18 | Dimensions | TBD | |
| 1.19 | Ambient Operating | 15-32° C. | |
| | Temperature | (60-90° F.) | |
| 1.20 | Storage | 0-38° C. | |
| | Temperature for | (32-100° F.) | |
| | Printer Hardware | | |

| Reqt | | |
|---|---|---|
| ID # | Feature | Typical Requirement |
| | Section 2 Software | |
| 2.1 | Software Functionality | Software to provide functionality for control, design and user |
| | | interface. |
| 2.2 | Control Software | Software to provide control for the 3D printer movement and |
| | Functionality | operation. |
| 2.3 | Design Software | Design Software to create, modify, import, and export 3D |
| | Functionality | models for Conductive Ink and Filament. Design Software |
| | | shall, at a minimum, include the following features: |
| | | File management commands |
| | | Component placement commands |
| | | Wire routing commands |
| | | Display control commands |
| | | Coordinate system visual referencing |
| | | Ability to integrate the import file types with the capability |
| | | to route the Conductive Ink traces and place |
| | | components on or within a 3D object |
| | | Template design files, including at a minimum the |
| | | Demonstrators' design files A user expandable |
| | | component library |
| 2.4 | User Interface Software | User Interface Software runs on a laptop connected to the |
| | Functionality | 3D Printer and allows the user to access and control the 3D |
| | | Printer. |
| 2.5 | Print File Type | STL, G-code |
| 2.6 | Import File Types | STL, Eagle Schematic File |
| 2.7 | Export File Types | STL, G-code |
| 2.8 | User Interface Laptop | Windows (7+, 32/64 bit) |
| | Operating Systems | |
| | Section 3 Consumables Requirements | |
| 3.1 | Conductive Ink | Each Conductive Ink cartridge includes at least 2 mls of |
| | Cartridge Volume | Conductive Ink. |
| 3.2 | Filament Spool Quantity | Each Filament spool includes at least 2 lbs. of Filament. |
| 3.3 | Conductive Ink Material | The Conductive Ink material shall be a conductive silver ink |
| | | that can be printed on the Filament. |
| 3.4 | Conductive Ink | At least 1.5% the bulk conductivity of silver |
| | Resistivity | (1.59 × 10⁻⁸ ρ (Ω · m) at 20° C.) |
| 3.5 | Filament | PLA |
| 3.6 | Filament Diameter | 1.75 MM or 3 MM |
| 3.7 | Conductive Ink Storage | 10-25° C. |
| | Temperature | (50-77° F.) |

Accordingly, various embodiments of this 3D printing system facilitate the rapid, efficient printing of objects with embedded electronic components and electrically conductive paths or traces. This greatly simplifies the building of compact, functional 3D printed objects useful for a wide variety of applications, including prototyping, small lot manufacturing, etc.

Those skilled in the art will readily appreciate that all parameters listed herein are meant to be exemplary and actual parameters depend upon the specific application for which the methods, materials, and apparatus of the present invention are used. It is, therefore, to be understood that the foregoing embodiments are presented by way of example only and that, within the scope of the appended claims and equivalents thereto, the invention may be practiced otherwise than as specifically described. Various materials, geometries, sizes, and interrelationships of elements may be practiced in various combinations and permutations, and all such variants and equivalents are to be considered part of the invention.

What is claimed is:

1. A three-dimensional printer comprising:
a dispensing system comprising at least two removable cartridges adapted to dispense different materials, wherein each removable cartridge includes a plurality of discrete status pins that provide data to identify the corresponding removable cartridge and a build material disposed therein;
a build surface disposed below the dispensing system;
a multi-axis positioning system adapted to position the dispensing system relative to the build surface; and
a plurality of status pin connections structured and arranged to mate with corresponding discrete status pins and configured to transfer data comprising at least one of an identity of each cartridge, properties of an associated build material dispenser, and properties of a build material disposed therein.

2. The three-dimensional printer of claim 1, wherein at least one of the removable cartridges is selected from the group consisting of a pneumatically controlled cartridge, a volumetric dispensed cartridge, an auger-type system, a syringe pump, and any combination of an auger-type system and a pneumatically controlled cartridge.

3-5. (canceled)

6. The three-dimensional printer of claim 1, wherein at least two cartridges comprise pneumatically controlled cartridges.

7. (canceled)

8. The three-dimensional printer of claim 1, wherein the dispensing system comprises a fused filament fabrication (FFF) cartridge for extruding a filament.

9. (canceled)

10. The three-dimensional printer of claim 1, wherein a dispensing tip of a first cartridge is translatable relative to a dispensing tip of at least one other cartridge.

11. The three-dimensional printer of claim 1, wherein a first cartridge comprises a capping arm adapted to cover a dispensing tip thereof.

12. The three-dimensional printer of claim 1, wherein a first cartridge is a pneumatically controlled cartridge comprising a syringe holder for receiving a syringe therein.

13-15. (canceled)

16. The three-dimensional printer of claim 1, wherein the dispensing system comprises a cartridge holder for holding the removable cartridges.

17-20. (canceled)

21. The three-dimensional printer of claim 1, wherein the multi-axis positioning system comprises (i) an xy-axes subsystem for positioning the dispensing system in a horizontal plane and (ii) a z-axis subsystem for positioning the build surface in a vertical direction.

22-27. (canceled)

28. The three-dimensional printer of claim 1 further comprising a plurality of sensors, wherein at least one of the sensors comprises a current monitoring circuit that monitors and generates signal data of current flow to the three-dimensional printer.

29. (canceled)

30. A method for three-dimensionally printing an object, the method comprising:
providing a three-dimensional printer including (i) a dispensing system comprising at least two removable cartridges adapted to dispense different materials, wherein each removable cartridge includes a plurality of discrete status pins that provide data to identify the corresponding removable cartridge and a build material therein; (ii) a build surface disposed below the dispensing system; (iii) a multi-axis positioning system adapted to position the dispensing system relative to the build surface; and (iv) a plurality of status pin connections;
mating the plurality of status pin connections with corresponding discrete status pins;
receiving status pin data with the status pin connections to identify the corresponding removable cartridge and the build material therein;
dispensing a structural material from one of the removable cartridges onto the build surface to define at least a portion of the object; and
dispensing a functional ink from another of the cartridges onto a region of the object.

31. The method of claim 30, wherein the functional ink is dispensed at room temperature.

32. The method of claim 30, wherein the functional ink is selected from the group consisting of conductive, magnetic, dielectric, and semiconductor materials.

33. The method of claim 30, wherein at least two cartridges comprise pneumatically controlled cartridges.

34-36. (canceled)

37. The method of claim 30, wherein the dispensing system comprises a fused filament fabrication (FFF) cartridge for extruding a filament, and dispensing the structural material comprises extruding the filament.

38. (canceled)

39. The method of claim 30, wherein a dispensing tip of a first cartridge is translatable relative to a dispensing tip of at least one other cartridge.

40-49. (canceled)

50. The method of claim 30, wherein the multi-axis positioning system comprises (i) an xy-axes subsystem for positioning the dispensing system in a horizontal plane; and (ii) a z-axis subsystem for positioning the build surface in a vertical direction.

51-59. (canceled)

60. A three-dimensional printer comprising:
a dispensing system;
a build surface disposed below the dispensing system;
a multi-axis positioning system adapted to position the dispensing system relative to the build surface; and
a temperature control unit in thermal communication with the build surface for controlling a temperature of the build surface.

61. The three-dimensional printer of claim 60 further comprising a key resistor formed in the thermal control unit.

62. The three-dimensional printer of claim 60 further comprising a thermistor formed in the thermal control unit.

63-78. (canceled)
